(19) United States
(12) Patent Application Publication
(10) Pub. No.: US 2025/0102795 A1
(43) Pub. Date: Mar. 27, 2025

(54) IMAGING LENS AND IMAGING APPARATUS

(71) Applicant: FUJIFILM Corporation, Tokyo (JP)

(72) Inventors: Takashi KUNUGISE, Saitama-shi (JP); Yu KITAHARA, Saitama-shi (JP); Toshihiro AOI, Saitama-shi (JP); Ryoko OTOMO, Saitama-shi (JP)

(73) Assignee: FUJIFILM Corporation, Tokyo (JP)

(21) Appl. No.: 18/890,883

(22) Filed: Sep. 20, 2024

(30) Foreign Application Priority Data
Sep. 26, 2023 (JP) 2023-163705

(51) Int. Cl. G02B 27/00; G02B 13/14

(52) U.S. Cl. CPC G02B 27/0025; G02B 13/14

(57) ABSTRACT

The imaging lens includes a plurality of lenses and a stop. Assuming that a refractive index of each lens included in the imaging lens at a wavelength of 4000 nm is N4, at least one lens of the plurality of lenses is an LA lens that satisfies N4<1.5, and at least one lens of the plurality of lenses is an LB lens that satisfies 2<N4.

### CROSS-REFERENCE TO RELATED APPLICATIONS

This application claims priority from Japanese Patent Application No. 2023-163705, filed on Sep. 26, 2023, the entire disclosure of which is incorporated herein by reference.

### BACKGROUND

### Technical Field

A technique of the present disclosure relates to an imaging lens and an imaging apparatus.

### Related Art

In the related art, infrared light has been used for imaging of factory automation (FA) cameras, machine vision (MV) cameras, surveillance cameras, in-vehicle cameras, and the like. For example, as an infrared camera lens system, a lens system disclosed in JP1999-287950A (JP-H11-287950A) is known.

### SUMMARY

There is a demand for an imaging lens that maintains favorable optical performance by correcting various aberrations including chromatic aberration in a medium infrared wavelength range. The demand level is increasing year by year.

The present disclosure provides the imaging lens that maintains favorable optical performance by correcting various aberrations including chromatic aberration in the medium infrared wavelength range, and an imaging apparatus comprising the imaging lens.

According to an aspect of the present disclosure, there is provided an imaging lens comprising: a plurality of lenses; and a stop, in which assuming that a refractive index of each lens included in the imaging lens at a wavelength of 4000 nm is N4, at least one lens of the plurality of lenses is an LA lens that satisfies Conditional Expression (1A) represented by

N4<1.5 (1A), and

at least one lens of the plurality of lenses is an LB lens that satisfies Conditional Expression (1B) represented by

2<N4 (1B).

In the above-mentioned aspect, it is preferable that at least one LA lens is disposed closer to an object side than the stop.

In the above-mentioned aspect, it is preferable that at least one LB lens is disposed closer to an object side than the stop.

In the above-mentioned aspect, it is preferable that at least one LA lens is disposed closer to an image side than the stop.

In the above-mentioned aspect, it is preferable that at least one LB lens is disposed closer to an image side than the stop.

The imaging lens according to the above-mentioned aspect may be configured to include at least two aspherical lenses.

It is preferable that all the lenses included in the imaging lens according to the above-mentioned aspect satisfy Conditional Expression (1C) represented by

N4<5 (1C).

Assuming that a sum of a distance on an optical axis from a lens surface closest to an object side in the imaging lens to a lens surface closest to an image side in the imaging lens and a back focal length of the imaging lens in terms of an air-equivalent distance at the wavelength of 4000 nm is TL, and a focal length of the imaging lens at the wavelength of 4000 nm is f, it is preferable that the imaging lens according to the above-mentioned aspect satisfies Conditional Expression (2) represented by

TL/f<20 (2).

Assuming that a back focal length of the imaging lens in terms of an air-equivalent distance at the wavelength of 4000 nm is Bf, and a focal length of the imaging lens at the wavelength of 4000 nm is f, it is preferable that the imaging lens according to the above-mentioned aspect satisfies Conditional Expression (3) represented by

0.3<Bf/f (3).

Assuming that a refractive index of each lens included in the imaging lens at a wavelength of 3000 nm is N3, and a refractive index of each lens included in the imaging lens at a wavelength of 5000 nm is N5, it is preferable that the imaging lens according to the above-mentioned aspect includes at least one aspherical lens that satisfies Conditional Expression (4A) represented by

100<(N4−1)/(N3−N5)<400 (4A).

It is preferable that at least one lens of the lenses included in the imaging lens is a lens having a concave lens surface, and at least one lens of the lenses included in the imaging lens is a lens having a convex lens surface, assuming that a refractive index of each lens included in the imaging lens at a wavelength of 3000 nm is N3, and a refractive index of each lens included in the imaging lens at a wavelength of 5000 nm is N5, at least one lens having the concave lens surface satisfies Conditional Expression (4B) represented by

0<(N4−1)/(N3−N5)<180 (4B), and

at least one lens having the convex lens surface satisfies Conditional Expression (4C) represented by

180<(N4−1)/(N3−N5)<400 (4C).

Assuming that a refractive index of each lens included in the imaging lens at a wavelength of 3000 nm is N3, and a refractive index of each lens included in the imaging lens at a wavelength of 5000 nm is N5, it is preferable that the imaging lens according to the above-mentioned aspect includes at least one spherical lens that satisfies Conditional Expression (4D) represented by

0<(N4−1)/(N3−N5)<250 (4D).

It is preferable that the imaging lens according to the above-mentioned aspect includes at least three lenses.

Assuming that a sum of a distance on an optical axis from a lens surface closest to an object side in the imaging lens to a lens surface closest to an image side in the imaging lens and a back focal length of the imaging lens in terms of an air-equivalent distance at the wavelength of 4000 nm is TL, and a maximum image height of the imaging lens is Y, it is preferable that the imaging lens according to the above-mentioned aspect satisfies Conditional Expression (5) represented by

0.5<TL/2Y<20 (5).

Assuming that a composite focal length of all the lenses closer to an object side than the stop at the wavelength of 4000 nm is fF, and a composite focal length of all the lenses closer to an image side than the stop at the wavelength of 4000 nm is fR, it is preferable that the imaging lens according to the above-mentioned aspect satisfies Conditional Expression (6) represented by

|fF/fR|<40 (6).

It is preferable that the LA lens is made of a crystalline material.

The imaging lens may be configured to include, successively in order from the position closest to the object side to the image side, a first lens that has a positive or negative refractive power, a second lens that has a positive refractive power, and a third lens that has a negative refractive power.

It is preferable that a negative lens is disposed adjacent to an image side of the stop. In the configuration in which the negative lens is disposed adjacent to the image side of the stop, a positive lens may be configured to be disposed adjacent to the image side of the negative lens.

According to another aspect of the present disclosure, there is provided an imaging apparatus comprising: the imaging lens according to the aspect of the present disclosure; and an imaging element that captures an image formed by the imaging lens according to the aspect of the present disclosure.

In the present specification, it should be noted that the terms “consisting of” and “consists of” mean that the lens may include not only the above-mentioned constituent elements but also lenses substantially having no refractive powers, optical elements, which are not lenses, such as a stop, a filter, and a cover glass, and mechanism parts such as a lens flange, a lens barrel, an imaging element, and a camera shaking correction mechanism.

The medium infrared wavelength range in the present specification indicates a wavelength range of 3000 nm to 5000 nm. The “nm” used as a unit of wavelength is nanometer. In the present specification, the aspherical lens is a lens in which at least one lens surface has an aspherical shape, and the spherical lens is a lens in which two lens surfaces on the object side and the image side each have a spherical shape. In the present specification, a compound aspherical lens (in which a lens (for example, a spherical lens) and an aspherical film formed on the lens are integrally formed and function as one aspherical lens as a whole) is not regarded as a cemented lens, but the compound aspherical lens is regarded as one lens. The curvature radius, the sign of the refractive power, and the surface shape of the lens including the aspherical surface will be used in terms of the paraxial region unless otherwise specified.

The “focal length” used in a conditional expression is a paraxial focal length. Unless otherwise specified, the “distance on the optical axis” used in Conditional Expression is considered as a geometrical distance. Unless otherwise specified, values used in Conditional Expressions are values in a state in which the infinite distance object is in focus.

According to the present disclosure, it is possible to provide an imaging lens that maintains favorable optical performance by correcting various aberrations including chromatic aberration in a medium infrared wavelength range, and an imaging apparatus comprising the imaging lens.

### BRIEF DESCRIPTION OF THE DRAWINGS

FIG. 1 is a cross-sectional view showing a configuration and luminous flux of an imaging lens according to an embodiment, which corresponds to the imaging lens according to Example 1.

FIG. 2 is a cross-sectional view showing a configuration of an imaging lens according to Example 1.

FIG. 3 is a diagram showing aberrations of the imaging lens according to Example 1.

FIG. 4 is a cross-sectional view showing a configuration of an imaging lens according to Example 2.

FIG. 5 is a diagram showing aberrations of the imaging lens according to Example 2.

FIG. 6 is a cross-sectional view showing a configuration of an imaging lens according to Example 3.

FIG. 7 is a diagram showing aberrations of the imaging lens according to Example 3.

FIG. 8 is a cross-sectional view showing a configuration of an imaging lens according to Example 4.

FIG. 9 is a diagram showing aberrations of the imaging lens according to Example 4.

FIG. 10 is a cross-sectional view showing a configuration of an imaging lens according to Example 5.

FIG. 11 is a diagram showing aberrations of the imaging lens according to Example 5.

FIG. 12 is a cross-sectional view showing a configuration of an imaging lens according to Example 6.

FIG. 13 is a diagram showing aberrations of the imaging lens according to Example 6.

FIG. 14 is a cross-sectional view showing a configuration of an imaging lens according to Example 7.

FIG. 15 is a diagram showing aberrations of the imaging lens according to Example 7.

FIG. 16 is a cross-sectional view showing a configuration of an imaging lens according to Example 8.

FIG. 17 is a diagram showing aberrations of the imaging lens according to Example 8.

FIG. 18 is a cross-sectional view showing a configuration of an imaging lens according to Example 9.

FIG. 19 is a diagram showing aberrations of the imaging lens according to Example 9.

FIG. 20 is a cross-sectional view showing a configuration of an imaging lens according to Example 10.

FIG. 21 is a diagram showing aberrations of the imaging lens according to Example 10.

FIG. 22 is a cross-sectional view showing a configuration of an imaging lens according to Example 11.

FIG. 23 is a diagram showing aberrations of the imaging lens according to Example 11.

FIG. 24 is a cross-sectional view showing a configuration of an imaging lens according to Example 12.

FIG. 25 is a diagram showing aberrations of the imaging lens according to Example 12.

FIG. 26 is a cross-sectional view showing a configuration of an imaging lens according to Example 13.

FIG. 27 is a diagram showing aberrations of the imaging lens according to Example 13.

FIG. 28 is a cross-sectional view showing a configuration of an imaging lens according to Example 14.

FIG. 29 is a diagram showing aberrations of the imaging lens according to Example 14.

FIG. 30 is a cross-sectional view showing a configuration of an imaging lens according to Example 15.

FIG. 31 is a diagram showing aberrations of the imaging lens according to Example 15.

FIG. 32 is a cross-sectional view showing a configuration of an imaging lens according to Example 16.

FIG. 33 is a diagram showing aberrations of the imaging lens according to Example 16.

FIG. 34 is a cross-sectional view showing a configuration of an imaging lens according to Example 17.

FIG. 35 is a diagram showing aberrations of the imaging lens according to Example 17.

FIG. 36 is a cross-sectional view showing a configuration of an imaging lens according to Example 18.

FIG. 37 is a diagram showing aberrations of the imaging lens according to Example 18.

FIG. 38 is a cross-sectional view showing a configuration of an imaging lens according to Example 19.

FIG. 39 is a diagram showing aberrations of the imaging lens according to Example 19.

FIG. 40 is a schematic configuration diagram of an imaging apparatus according to an embodiment.

### DESCRIPTION OF EMBODIMENTS

Hereinafter, embodiments of the present disclosure will be described with reference to the accompanying drawings. In the following description, in order to avoid redundancy, the same symbols are used for the symbols having the same definitions in the expressions, and the repeated description of the symbols will be omitted.

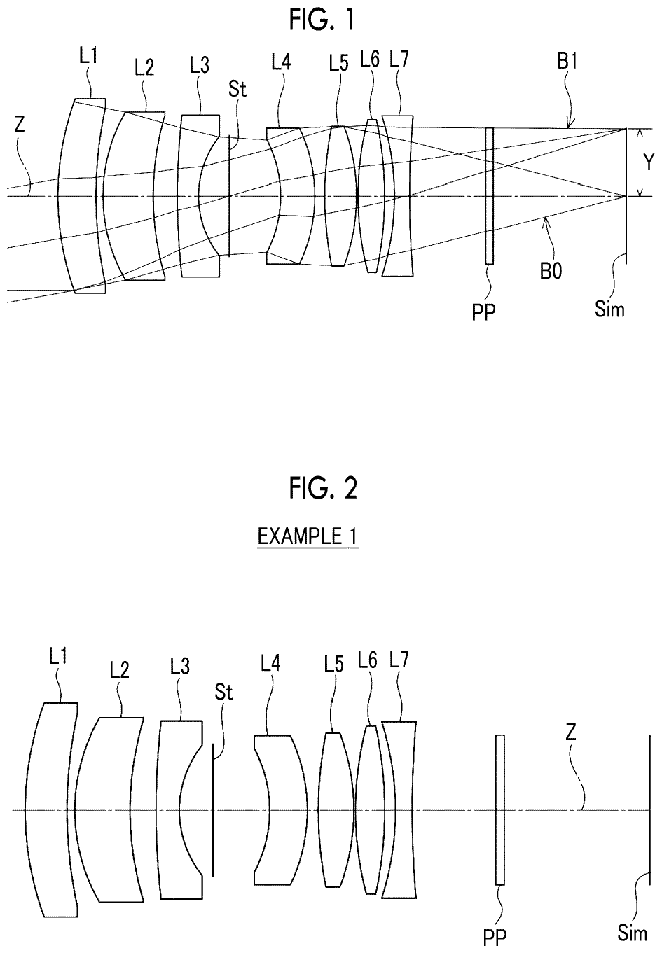

FIG. 1 shows a cross-sectional view of a configuration and luminous flux of the imaging lens according to a first embodiment of the present disclosure. In FIG. 1, the luminous flux includes an on-axis luminous flux B0 and an off-axis luminous flux B1 at a maximum half angle of view. FIG. 1 shows a state where an infinite distance object is in focus, in which the left side thereof is an object side, and the right side thereof is an image side. The example shown in FIG. 1 corresponds to the imaging lens according to Example 1 to be described later.

FIG. 1 shows an example in which, assuming that an imaging lens is applied to an imaging apparatus, an optical member PP having a parallel plate shape is disposed between the imaging lens and the image plane Sim. The optical member PP is a member assumed to include various filters, a cover glass, and/or the like. The optical member PP is a member that has no refractive power. It is also possible to configure the imaging apparatus by removing the optical member PP.

An imaging lens according to the embodiment of the present disclosure includes a plurality of lenses and an aperture stop St. For example, the imaging lens shown in FIG. 1 is a single focus lens and consists of lenses L1 to L3, an aperture stop St, and lenses L4 to L7, in order from the object side to the image side along the optical axis Z. The aperture stop St in FIG. 1 does not indicate the size or the shape thereof, but indicates the position thereof in the optical axis direction.

In the following expressions of the present specification, it is assumed that a refractive index of each lens included in the imaging lens at the wavelength of 4000 nm is N4. In addition, in the technique of the present disclosure, a lens satisfying Conditional Expression (1A) to be described later is referred to as an LA lens, and a lens satisfying Conditional Expression (1B) to be described later is referred to as an LB lens.

N4<1.5 (1A)

2<N4 (1B)

Further, in the technique of the present disclosure, v4 defined by the following expression is referred to as an Abbe number for convenience.

v4=(N4−1)/(N3−N5)

Here, it is assumed that a refractive index of each lens included in the imaging lens at a wavelength of 3000 nm is N3, and a refractive index of each lens included in the imaging lens at a wavelength of 5000 nm is N5. The above-mentioned Abbe number represents a degree of dispersion.

At least one of the plurality of lenses included in the imaging lens according to the embodiment of the present disclosure is composed of an LA lens and at least one of the plurality of lenses is composed of an LB lens. An optical material having a relatively low refractive index and used in a medium infrared wavelength range has a small Abbe number and large dispersion. Therefore, it is easy to correct chromatic aberration by using at least one LA lens satisfying Conditional Expression (1A). Further, an optical material having a relatively high refractive index and used in a medium infrared wavelength range has a large Abbe number and small dispersion. Therefore, it is possible to correct various aberrations while suppressing occurrence of chromatic aberration by using at least one LB lens satisfying Conditional Expression (1B). According to the technique of the present disclosure, by combining the LA lens and the LB lens, it is easy to provide the imaging lens in which various aberrations including chromatic aberration are satisfactorily corrected in a wide wavelength range of 3000 nm to 5000 nm.

For example, in the imaging lens of FIG. 1, lenses L2, L3, and L5 to L7 are LA lenses, and lenses L1 and L4 are LB lenses.

It is preferable that at least one of the LA lenses included in the imaging lens satisfies Conditional Expression (1A-1). By not allowing the corresponding value of Conditional Expression (1A-1) to be equal to or less than the lower limit thereof, it is easy to increase the refractive power of the lens that corrects chromatic aberration. Therefore, it is easy to enhance an effect of correcting chromatic aberration. It is more preferable that at least one of the LA lenses included in the imaging lens satisfies Conditional Expression (1A-2). It is yet more preferable that the lens satisfies Conditional Expression (1A-3). It is most preferable that the lens satisfies Conditional Expression (1A-4).

1.2<N4<1.5 (1A-1)

1.2<N4<1.47 (1A-2)

1.2<N4<1.45 (1A-3)

1.3<N4<1.42 (1A-4)

At least one of the LB lenses included in the imaging lens preferably satisfies Conditional Expression (1B-1), more preferably satisfies Conditional Expression (1B-2), yet more preferably satisfies Conditional Expression (1B-3), and most preferably satisfies Conditional Expression (1B-4). By not allowing the corresponding value of Conditional Expression (1B-3) to be equal to or greater than the upper limit value thereof, it is possible to select a material that can be used in practice. Further, by not allowing the corresponding value of Conditional Expression (1B-4) to be equal to or greater than the upper limit value thereof, it is easy to suppress the high cost of the material.

2.1<N4 (1B-1)

2.4<N4 (1B-2)

2.45<N4<5 (1B-3)

2.45<N4<4.5 (1B-4)

It is preferable that at least one LA lens is disposed closer to the object side than the aperture stop St. By disposing the LA lens closer to the object side than the aperture stop St, it is easy to correct chromatic aberration at a position closer to the object side than the aperture stop St. Therefore, it is easy to suppress chromatic aberration of the entire system.

It is preferable that at least one LB lens is disposed closer to the object side than the aperture stop St. By disposing the LB lens at a position closer to the object side than the aperture stop St, it is easy to suppress chromatic aberration occurring at the position closer to the object side than the aperture stop St. Therefore, it is easy to suppress chromatic aberration of the entirety.

It is preferable that at least one LA lens is disposed closer to the image side than the aperture stop St. By disposing the LA lens at a position closer to the image side than the aperture stop St, it is easy to correct chromatic aberration at the position closer to the image side than the aperture stop St. Therefore, it is easy to suppress chromatic aberration of the entirety.

It is preferable that at least one LB lens is disposed closer to the image side than the aperture stop St. By disposing the LB lens at a position closer to the image side than the aperture stop St, it is easy to suppress chromatic aberration occurring at the position closer to the image side than the aperture stop St. Therefore, it is easy to suppress chromatic aberration of the entirety.

It is preferable that at least two LB lenses are disposed closer to the image side than the aperture stop St. In such a case, it is easier to suppress chromatic aberration occurring at a position closer to the image side than the aperture stop St. Therefore, it is easier to suppress chromatic aberration of the entirety.

It is preferable that the LA lens is made of a crystalline material. By adopting a configuration using the crystalline material, the lens can have high transmittance in a wavelength range of 3000 nm to 5000 nm and a stable refractive index. Therefore, it is easy to stably manufacture a lens having favorable performance.

It is preferable that a lens or lenses composed of at least one crystalline material are disposed closer to the object side than the aperture stop St. In such a case, it is easy to correct chromatic aberration at a position closer to the object side than the aperture stop St, and thus it is easy to suppress chromatic aberration of the entirety.

It is preferable that a lens that is composed of at least one crystalline material is disposed closer to the image side than the aperture stop St. In such a case, it is easy to correct chromatic aberration at a position closer to the image side than the aperture stop St, and thus it is easy to suppress chromatic aberration of the entirety.

It is preferable that at least two lenses are disposed closer to the image side than the aperture stop St. In such a case, it is easy to satisfactorily correct various aberrations occurring at a position closer to the image side than the aperture stop St. As a result, there is an advantage in achieving high performance.

It is preferable that the imaging lens includes, at a position closer to the image side than the aperture stop St, a lens composed of at least two kinds of crystalline materials, and the at least two kinds of crystalline materials are different from each other among the lenses composed of the crystalline materials. In such a case, it is easy to further satisfactorily correct chromatic aberration in the lens at a position closer to the image side than the aperture stop St, and it is easy to correct chromatic aberration as a whole.

It is preferable that the imaging lens includes at least one aspherical lens. By using the aspherical lens, it is easy to satisfactorily correct various aberrations. It is more preferable that the imaging lens includes at least two aspherical lenses. By using the aspherical lens, it is easier to satisfactorily correct various aberrations.

It is preferable that all the lenses included in the imaging lens satisfy Conditional Expression (1C). By not allowing the corresponding value of Conditional Expression (1C) to be equal to or greater than the upper limit value thereof, it is possible to select a material that can be practically used. It is more preferable that all the lenses included in the imaging lens satisfy Conditional Expression (1C-1). It is yet more preferable that the lenses satisfy Conditional Expression (1C-2). It is most preferable that the lenses satisfy Conditional Expression (1C-3). It is especially preferable that the lenses satisfy Conditional Expression (1C-4). By not allowing the value corresponding to Conditional Expression (1C-1) to be equal to or greater than the upper limit value thereof, it is easy to suppress an increase in cost of the material. By not allowing the corresponding value of Conditional Expression (1C-3) to be equal to or less than the lower limit thereof, it is easy to increase the refractive power of each lens. Therefore, it is easy to achieve reduction in size thereof and correct chromatic aberration.

N4<5 (1C)

N4<4.5 (1C-1)

N4<4 (1C-2)

1.2<N4<3 (1C-3)

1.3<N4<3 (1C-4)

It is preferable that the imaging lens satisfies Conditional Expression (2). Here, it is assumed that a focal length of the imaging lens at the wavelength of 4000 nm is f. Further, it is assumed that a sum of a distance on the optical axis from the lens surface closest to the object side in the imaging lens to the lens surface closest to the image side in the imaging lens and a back focal length of the imaging lens in terms of an air-equivalent distance at the wavelength of 4000 nm is TL. By not allowing the corresponding value of Conditional Expression (2) to be equal to or greater than the upper limit value thereof, there is an advantage in achieving reduction in size thereof. It is more preferable that the imaging lens satisfies Conditional Expression (2-1) to be described later. It is yet more preferable that the imaging lens satisfies Conditional Expression (2-2) to be described later. It is most preferable that the imaging lens satisfies Conditional Expression (2-3) to be described later. By not allowing the corresponding value of Conditional Expression (2-1) to be equal to or less than the lower limit value thereof, it is easy to prevent an angle of view from becoming excessively small.

TL/f<20 (2)

0.5<TL/f<15 (2-1)

0.8<TL/f<12 (2-2)

1<TL/f<9 (2-3)

It is preferable that the imaging lens satisfies Conditional Expression (3). Here, it is assumed that the back focal length of the imaging lens at the air-equivalent distance of the wavelength of 4000 nm is Bf. By not allowing the corresponding value of Conditional Expression (3) to be equal to or less than the lower limit value thereof, it is easy to prevent the angle of view from becoming excessively small. It is more preferable that the imaging lens satisfies Conditional Expression (3-1). It is yet more preferable that the imaging lens satisfies Conditional Expression (3-2). By not allowing the corresponding value of Conditional Expression (3-1) to be equal to or greater than the upper limit thereof, the back focal length is prevented from becoming excessively long. Therefore, it is easy to prevent a total length from increasing.

0.3<Bf/f (3)

0.4<Bf/f<5 (3-1)

0.45<Bf/f<3 (3-2)

It is preferable that the imaging lens includes at least one lens that satisfies Conditional Expression (4A). A corresponding value of Conditional Expression (4A) is an Abbe number of the technique of the present disclosure. By not allowing the corresponding value of Conditional Expression (4A) to be equal to or less than the lower limit value thereof, the Abbe number is prevented from becoming excessively small. Therefore, dispersion is prevented from becoming excessively large. As a result, an amount of occurrence of chromatic aberration can be suppressed. By not allowing the corresponding value of Conditional Expression (4A) to be equal to or greater than the upper limit value thereof, the Abbe number is prevented from becoming excessively large. Therefore, the dispersion is prevented from becoming excessively small. As a result, there is an advantage in achieving reduction in cost of the material. It is more preferable that at least one of the lenses, which are included in the imaging lens and which satisfy Conditional Expression (4A), satisfies at least one of Conditional Expression (4A-1) or Conditional Expression (4A-2).

100<(N4−1)/(N3−N5)<400 (4A)

150<(N4−1)/(N3−N5)<200 (4A-1)

130<(N4−1)/(N3−N5)<180 (4A-2)

It is preferable that at least one of the lenses, which are included in the imaging lens and which satisfy Conditional Expression (4A), is an aspherical lens. In such a case, in addition to the effect of Conditional Expression (4A), an effect of easily correcting various aberrations can be obtained. It is more preferable that at least one of the aspherical lenses, which are included in the imaging lens and which satisfy Conditional Expression (4A), satisfies at least one of Conditional Expression (4A-1) or Conditional Expression (4A-2).

It is preferable that the imaging lens includes at least one lens that satisfies Conditional Expression (4B). A corresponding value of Conditional Expression (4B) is an Abbe number of the technique of the present disclosure. By using a lens which has large dispersion and which satisfies Conditional Expression (4B), it is easy to correct chromatic aberration. It is more preferable that at least one of the lenses, which are included in the imaging lens and which satisfy Conditional Expression (4B), satisfies Conditional Expression (4B-1). It is yet more preferable that the lens satisfies Conditional Expression (4B-2). It is most preferable that the lens satisfies Conditional Expression (4B-3).

0<(N4−1)/(N3−N5)<180 (4B)

80<(N4−1)/(N3−N5)<180 (4B-1)

120<(N4−1)/(N3−N5)<180 (4B-2)

140<(N4−1)/(N3−N5)<180 (4B-3)

Further, it is preferable that the imaging lens includes at least one lens that satisfies Conditional Expression (4C). A corresponding value of Conditional Expression (4C) is an Abbe number of the technique of the present disclosure. By using a lens which has small dispersion and which satisfies Conditional Expression (4C), it is easy to suppress occurrence of chromatic aberration. It is more preferable that at least one of the lenses, which are included in the imaging lens and which satisfy Conditional Expression (4C), satisfies Conditional Expression (4C-1). It is yet more preferable that the lens satisfies Conditional Expression (4C-2).

180<(N4−1)/(N3−N5)<400 (4C)

180<(N4−1)/(N3−N5)<300 (4C-1)

180<(N4−1)/(N3−N5)<220 (4C-2)

It is preferable that at least one of the plurality of lenses included in the imaging lens is a lens having a concave lens surface, at least one of the plurality of lenses is a lens having a convex lens surface, at least one of the lenses having a concave lens surface satisfies Conditional Expression (4B), and at least one of the lenses having a convex lens surface satisfies Conditional Expression (4C). By combining a lens having a concave lens surface and large dispersion and a lens having a convex lens surface and small dispersion to form the lens, it is easy to correct chromatic aberration. In the chromatic aberration correction using the above-mentioned combination, by not allowing the difference between the Abbe number of the lens having the concave lens surface and the Abbe number of the lens having the convex lens surface to be excessively large, overcorrection can be suppressed. In addition, by not allowing the difference to be excessively small, undercorrection can be suppressed.

In the combination, the lens having a concave lens surface more preferably satisfies Conditional Expression (4B-1), yet more preferably satisfies Conditional Expression (4B-2), and most preferably satisfies Conditional Expression (4B-3). Further, in the combination, it is more preferable that the lens having a convex lens surface satisfies Conditional Expression (4C-1), and it is yet more preferable that the lens satisfies Conditional Expression (4C-2).

It is preferable that the imaging lens includes at least one spherical lens that satisfies Conditional Expression (4D). A corresponding value of Conditional Expression (4D) is an Abbe number of the technique of the present disclosure. By not allowing the corresponding value of Conditional Expression (4D) to be equal to or less than the lower limit value thereof, the Abbe number is prevented from becoming excessively small. Therefore, the dispersion is prevented from becoming excessively large. As a result, it is easy to suppress chromatic aberration from occurring. By not allowing the corresponding value of Conditional Expression (4D) to be equal to or greater than the upper limit thereof, the Abbe number is prevented from becoming excessively large. Therefore, the dispersion is prevented from becoming excessively small. As a result, there is an advantage in achieving reduction in cost of the material. It is more preferable that at least one of the spherical lenses, which are included in the imaging lens and which satisfy Conditional Expression (4D), satisfies Conditional Expression (4D-1). It is yet more preferable that the lens satisfies Conditional Expression (4D-2). It is most preferable that the lens satisfies Conditional Expression (4D-3). It is especially preferable that the lens satisfies Conditional Expression (4D-4).

0<(N4−1)/(N3−N5)<250 (4D)

0<(N4−1)/(N3−N5)<200 (4D-1)

5<(N4−1)/(N3−N5)<100 (4D-2)

10<(N4−1)/(N3−N5)<80 (4D-3)

15(N4−1)/(N3−N5)<50 (4D-4)

It is preferable that the imaging lens satisfies Conditional Expression (5). Here, it is assumed that a maximum image height of the imaging lens is Y. For example, FIG. 1 shows a maximum image height Y. By not allowing the corresponding value of Conditional Expression (5) to be equal to or less than the lower limit thereof, the TL is prevented from becoming excessively small. Therefore, disposition of the lens is easy. As a result, there is an advantage in achieving high performance. By not allowing the corresponding value of Conditional Expression (5) to be equal to or greater than the upper limit value thereof, there is an advantage in achieving reduction in size thereof. It is more preferable that the imaging lens satisfies Conditional Expression (5-1). It is yet more preferable that the imaging lens satisfies Conditional Expression (5-2). It is even more preferable that the imaging lens satisfies Conditional Expression (5-3). It is most preferable that the imaging lens satisfies Conditional Expression (5-4). It is especially preferable that the imaging lens satisfies Conditional Expression (5-5).

0.5<TL/2Y<20 (5)

0.5<TL/2Y<18 (5-1)

0.8<TL/2Y<15 (5-2)

1<TL/2Y<14 (5-3)

1.5<TL/2Y<12 (5-4)

1.5<TL/2Y<8.5 (5-5)

It is preferable that the imaging lens satisfies Conditional Expression (6). Here, it is assumed that a composite focal length of all the lenses closer to the object side than the aperture stop St at the wavelength of 4000 nm is fF. A composite focal length of all the lenses closer to the image side than the aperture stop St at the wavelength of 4000 nm is fR. By satisfying the numerical range of Conditional Expression (6), it is possible to appropriately maintain a balance between the refractive power of the group on the object side of the aperture stop St and the refractive power of the group on the image side. Thus, it is easy to correct spherical aberration and field curvature. In order to more appropriately maintain the above-mentioned balance, it is more preferable that the imaging lens satisfies a numerical range of Conditional Expression (6-1), it is yet more preferable that the imaging lens satisfies a numerical range of Conditional Expression (6-2), it is most preferable that the imaging lens satisfies a numerical range of Conditional Expression (6-3), and it is especially preferable that the imaging lens satisfies a numerical range of Conditional Expression (6-4).

|fF/fR|<40 (6)

0.1<|fF/fR|<30 (6-1)

0.15<|fF/fR|<20 (6-2)

0.4<|fF/fR|<19 (6-3)

1<|fF/fR|<15 (6-4)

The group consisting of all the lenses closer to the object side than the aperture stop St may be configured as a group that has a positive refractive power as a whole. In such a case, it is easy to reduce the size of the lens system.

Alternatively, the group consisting of all the lenses closer to the object side than the aperture stop St may be configured as a group that has a negative refractive power as a whole. In such a case, it is easy to achieve an increase in angle of view.

It is preferable that the group consisting of all the lenses closer to the image side than the aperture stop St has a positive refractive power as a whole. In such a case, it is easy to reduce the size of the lens system.

A negative lens may be configured to be disposed adjacent to the image side of the aperture stop St. In such a case, it is easy to satisfactorily correct longitudinal chromatic aberration and chromatic aberration of magnification. A negative lens may be configured to be disposed adjacent to the image side of the aperture stop St, and a positive lens may be configured to be disposed adjacent to the image side of the negative lens. In such a case, it is easier to satisfactorily correct longitudinal chromatic aberration and chromatic aberration of magnification.

The imaging lens may be configured to include an aperture stop St, a negative lens, a positive lens, and a negative lens, successively in order from the object side to the image side. In such a case, it is easier to satisfactorily correct longitudinal chromatic aberration and chromatic aberration of magnification. Alternatively, the imaging lens may be configured to include an aperture stop St, a negative lens, a positive lens, and a positive lens, in order from the object side to the image side. In such a case, it is easy to satisfactorily correct spherical aberration in addition to longitudinal chromatic aberration and chromatic aberration of magnification.

The imaging lens may be configured to include an aperture stop St, a negative lens, a positive lens, a negative lens, a positive lens, a negative lens, and a positive lens, successively in order from the object side to the image side. In such a case, it is easy to satisfactorily correct various aberrations by combining the negative lens and the positive lens.

It is preferable that the imaging lens includes at least three lenses. Since the imaging lens includes three or more lenses, it is easy to correct various aberrations and chromatic aberrations by combining the lenses.

The number of lenses included in the imaging lens may be equal to or less than 12. In such a case, it is easy to achieve reduction in size thereof. In order to further reduce the size thereof, the number of lenses included in the imaging lens is preferably equal to or less than 9, more preferably equal to or less than 7, and still more preferably equal to or less than 4.

A lens closest to the object side in the imaging lens may be configured as a positive lens. In such a case, there are advantages in achieving reduction in size of the lens system and correcting distortion. In a case where the lens closest to the object side in the imaging lens is a positive lens, the lens closest to the object side may be configured as the LA lens. In such a case, it is easy to suppress chromatic aberration while achieving reduction in size of the lens system. Alternatively, in a case where the lens closest to the object side in the imaging lens is a positive lens, the lens closest to the object side may be configured as the LB lens. In such a case, it is easy to suppress various aberrations such as field curvature while achieving reduction in size of the lens system.

The lens closest to the object side in the imaging lens may be configured as a negative lens. In such a case, there is an advantage in achieving an increase in angle of view. In a case where the lens closest to the object side in the imaging lens is a negative lens, it is preferable that the lens closest to the object side is the LB lens. By disposing the negative lens consisting of a material having a refractive index of greater than 2 at a position closest to the object side at the wavelength of 4000 nm, it is easy to increase the back focal length while achieving an increase in angle of view of the lens system.

The lens, which is second from the object side in the imaging lens, may be configured as a positive lens. In such a case, there is an advantage in correcting field curvature. Alternatively, the lens, which is second from the object side in the imaging lens, may be configured as a negative lens. In such a case, there are advantages in achieving an increase in angle of view and ensuring the back focal length.

The lens, which is third from the object side in the imaging lens, may be configured as a positive lens. In such a case, there is an advantage in correcting spherical aberration and field curvature. Alternatively, the lens, which is third from the object side in the imaging lens, may be configured as a negative lens. In such a case, there is an advantage in correcting longitudinal chromatic aberration and chromatic aberration of magnification.

The lens, which is fourth from the object side in the imaging lens, may be configured as a positive lens. In such a case, there is an advantage in correcting spherical aberration and field curvature. Alternatively, the lens, which is fourth from the object side in the imaging lens, may be configured as a negative lens. In such a case, there is an advantage in correcting longitudinal chromatic aberration and chromatic aberration of magnification.

The imaging lens may be configured to include, successively in order from the position closest to the object side to the image side, a first lens that has a positive or negative refractive power, a second lens that has a positive refractive power, and a third lens that has a negative refractive power. In such a case, it is easy to realize a lens system which has a small size and in which spherical aberration and field curvature are satisfactorily corrected.

The imaging lens may be configured to include, successively in order from the position closest to the object side to the image side, a first lens that has a positive or negative refractive power, a second lens that has a positive refractive power, a third lens that has a negative refractive power, and a fourth lens that has a positive refractive power. In such a case, it is easy to satisfactorily correct various aberrations by combining the negative lens and the positive lens.

The imaging lens may be configured to include, successively in order from the position closest to the object side to the image side, a first lens that has a positive refractive power, a second lens that has a negative refractive power, a third lens that has a positive refractive power, a fourth lens that has a positive or negative refractive power, and a fifth lens that has a positive refractive power. In such a case, it is easy to satisfactorily correct various aberrations by combining the negative lens and the positive lens.

The imaging lens may be configured to include, successively in order from the position closest to the object side to the image side, a first lens that has a positive refractive power, a second lens that has a positive or negative refractive power, a third lens that has a negative refractive power, a fourth lens that has a positive refractive power, and a fifth lens that has a positive refractive power. In such a case, it is easy to satisfactorily correct various aberrations by combining the negative lens and the positive lens.

The imaging lens may be configured to include, successively in order from the position closest to the object side to the image side, a first lens that has a positive refractive power, a second lens that has a positive refractive power, a third lens that has a negative refractive power, a fourth lens that has a positive or negative refractive power, a fifth lens that has a positive refractive power, and a sixth lens that has a positive refractive power. In such a case, it is easy to satisfactorily correct various aberrations by combining the negative lens and the positive lens.

The imaging lens may be configured to include, successively in order from the position closest to the object side to the image side, a first lens that has a positive refractive power, a second lens that has a positive refractive power, a third lens that has a negative refractive power, a fourth lens that has a positive or negative refractive power, a fifth lens that has a positive refractive power, a sixth lens that has a positive refractive power, and a seventh lens that has a negative refractive power. In such a case, it is easy to satisfactorily correct various aberrations by combining the negative lens and the positive lens.

The imaging lens may be configured to include, successively in order from the position closest to the object side to the image side, a first lens that has a negative refractive power, a second lens that has a positive or negative refractive power, a third lens that has a positive refractive power, a fourth lens that has a positive or negative refractive power, a fifth lens that has a negative refractive power, a sixth lens that has a positive refractive power, a seventh lens that has a negative refractive power, an eighth lens that has a positive refractive power, a ninth lens that has a negative refractive power, a tenth lens that has a positive refractive power, an eleventh lens that has a negative refractive power, and a twelfth lens that has a positive refractive power. In such a case, it is easy to satisfactorily correct various aberrations by combining the negative lens and the positive lens.

The example shown in FIG. 1 is an example, and as exemplified above, various modifications can be made without departing from the scope of the technique of the present disclosure. For example, the number of LA lenses included in the imaging lens, the number of LB lenses, and the total number of lenses of the whole system may be different from those in the example of FIG. 1. A position of the aperture stop St may be a position different from that in the example of FIG. 1.

The above-mentioned preferred configurations and available configurations may be optional combinations, and it is preferable to selectively adopt the configurations in accordance with required specifications. The conditional expressions that the imaging lens preferably satisfies are not limited to the conditional expressions described in the form of the expression, and the lower limit and the upper limit are selected from the preferable and more preferably listed conditional expressions. The conditional expressions may include all conditional expressions obtained through optional combinations.

For example, according to a preferred embodiment of the present disclosure, the imaging lens includes at least one LA lens, at least one LB lens, and the aperture stop St.

Next, examples of the imaging lens according to the embodiment of the present disclosure will be described, with reference to the drawings. The reference numerals attached to the lenses in the cross-sectional views of each example are used independently for each example in order to avoid complication of description and drawings due to an increase in number of digits of the reference numerals. Therefore, even in a case where common reference numerals are attached in the drawings of different examples, components do not necessarily have a common configuration.

### Example 1

FIG. 2 is a cross-sectional view of a configuration of an imaging lens according to Example 1. In FIG. 2, the illustration of the luminous flux is omitted as compared with FIG. 1, but the basic illustration method of FIG. 2 is the same as that of FIG. 1. Thus, the repeated description will be partially omitted here. The imaging lens according to Example 1 consists of lenses L1 to L3, an aperture stop St, and lenses L4 to L7, in order from the object side to the image side.

Table 1 shows basic lens data of the imaging lens according to Example 1. The table of basic lens data will be described as follows. The “Sn” column shows surface numbers in a case where the surface closest to the object side is the first surface and the number is increased one by one toward the image side. The “R” column shows a curvature radius of each surface. The “D” column shows a surface spacing between each surface and the surface adjacent to the image side on the optical axis. The “N4” column shows a refractive index of each component at the wavelength of 4000 nm. The “N3” column shows a refractive index of each component at a wavelength of 3000 nm. The “N5” column shows a refractive index of each component at a wavelength of 5000 nm. The “Material” column shows a material name of each component. The “(N4−1)/(N3−N5)” column shows corresponding values of Conditional Expressions (4A), (4B), (4C), and (4D), that is, the Abbe numbers in the technique of the present disclosure.

In the table of the basic lens data, the sign of the curvature radius of the surface convex toward the object side is positive, and the sign of the curvature radius of the surface convex toward the image side is negative. In a cell of a surface number of a surface corresponding to the aperture stop St, the surface number and a term of (St) are noted. The table of basic lens data also shows the optical member PP. A value at the bottom cell of the D column in the table indicates a spacing between the image plane Sim and the surface closest to the image side in the table.

Table 2 shows the specifications of the imaging lens according to Example 1 at the wavelength of 4000 nm. The table of the specifications shows the focal length f, the back focal length Bf at the air-equivalent distance, the F number FNo., the maximum total angle of view 2ω, and the maximum image height Y. [°] in the column of the maximum total angle of view indicates the unit is degrees.

In the data of each table, degrees are used as a unit of an angle, and millimeters (mm) are used as a unit of a length, but appropriate different units may be used since the optical system can be used even in a case where the system is enlarged or reduced in proportion. Each of the following tables shows numerical values rounded off to predetermined decimal places.

TABLE 1
Example 1

| | | | | | | | (N4-1)/ |
|---|---|---|---|---|---|---|---|
| Sn | R | D | N4 | N3 | N5 | Material | (N3-N5) |
| 1 | 36.9449 | 5.000 | 2.43314 | 2.43756 | 2.42951 | ZnSe | 178.02 |
| 2 | 54.2225 | 0.927 | | | | | |
| 3 | 22.0005 | 6.600 | 1.34928 | 1.36647 | 1.32659 | LiF | 8.76 |
| 4 | 37.3284 | 3.100 | | | | | |
| 5 | 93.7740 | 2.783 | 1.34928 | 1.36647 | 1.32659 | LiF | 8.76 |
| 6 | 12.5087 | 4.012 | | | | | |
| 7 (St) | ∞ | 6.766 | | | | | |
| 8 | −15.9353 | 4.500 | 4.02506 | 4.04448 | 4.01628 | Ge | 107.29 |
| 9 | −20.6014 | 1.316 | | | | | |
| 10 | 46.7383 | 4.167 | 1.40964 | 1.41785 | 1.39896 | CaF2 | 21.68 |
| 11 | −26.2180 | 0.200 | | | | | |
| 12 | 39.4862 | 3.483 | 1.40964 | 1.41785 | 1.39896 | CaF2 | 21.68 |
| 13 | −47.5513 | 1.289 | | | | | |
| 14 | −34.4718 | 2.000 | 1.34928 | 1.36647 | 1.32659 | LiF | 8.76 |
| 15 | 119.9503 | 10.000 | | | | | |
| 16 | ∞ | 1.000 | 1.67524 | 1.71224 | 1.62397 | SAPPHIRE | 7.65 |
| 17 | ∞ | 17.402 | | | | | |

TABLE 2
Example 1

| | |
|---|---|
| f | 49.89 |
| Bf | 28.00 |
| FNo. | 2.02 |
| 2ω [°] | 20.4 |
| Y | 8.80 |

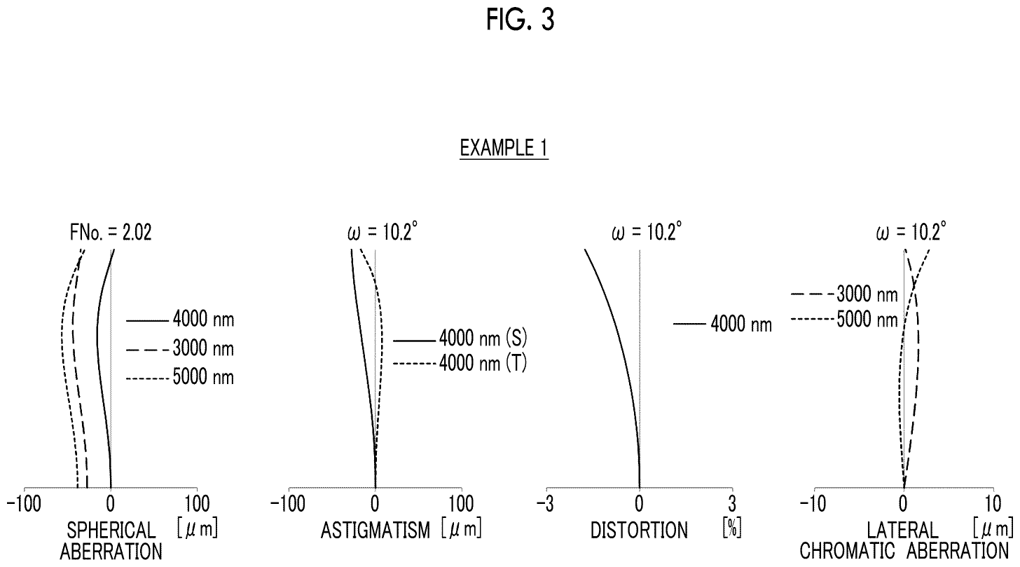

FIG. 3 shows aberration diagrams of the imaging lens according to Example 1 in a state where the infinite distance object is in focus. FIG. 3 shows spherical aberration, astigmatism, distortion, and lateral chromatic aberration, in order from the left side. In the spherical aberration diagram, aberrations at the wavelength of 4000 nm, the wavelength of 3000 nm, and the wavelength of 5000 nm are indicated by a solid line, a long broken line, and a short broken line, respectively. In the astigmatism diagram, aberration in the sagittal direction at the wavelength of 4000 nm is indicated by the solid line, and aberration in the tangential direction at the wavelength of 4000 nm is indicated by the short broken line. In the distortion diagram, aberration at the wavelength of 4000 nm is indicated by the solid line. In the lateral chromatic aberration diagram, aberrations at the wavelength of 3000 nm and the wavelength of 5000 nm are indicated by the long broken line and the short broken line, respectively. In the spherical aberration diagram, a value of the F number is shown after “FNo.=”. In other aberration diagrams, the value of the maximum half angle of view is shown after “@=”.

Symbols, meanings, description methods, and illustration methods of the respective data pieces according to Example 1 are basically similar to those in the following examples unless otherwise specified. Therefore, in the following description, repeated description will not be given.

### Example 2

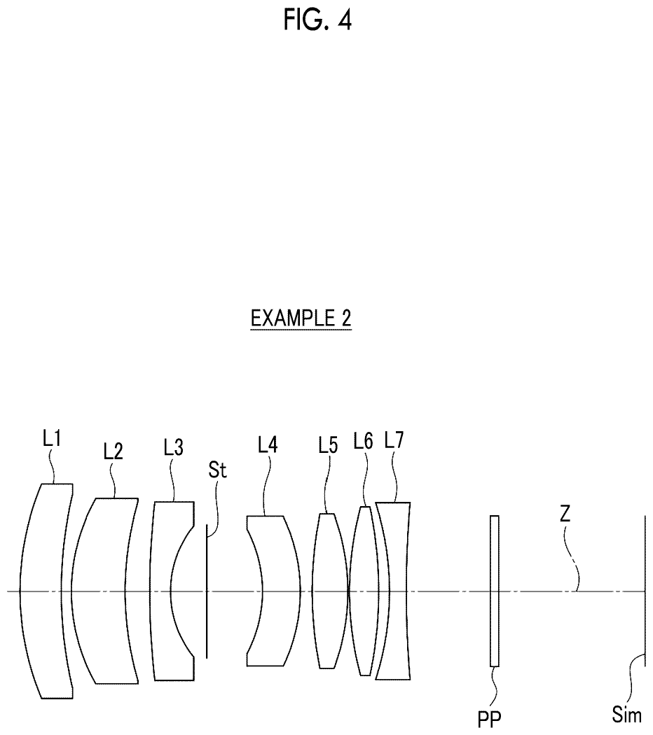

FIG. 4 is a cross-sectional view of a configuration of an imaging lens according to Example 2. The imaging lens according to Example 2 consists of lenses L1 to L3, an aperture stop St, and lenses L4 to L7, in order from the object side to the image side.

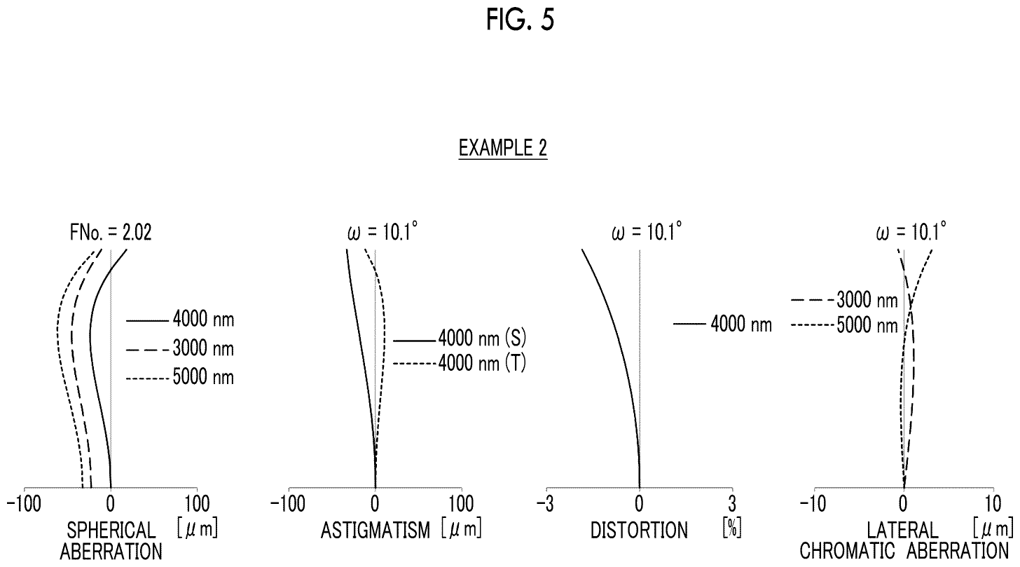

Regarding the imaging lens according to Example 2, Table 3 shows basic lens data, Table 4 shows specifications, and FIG. 5 shows aberration diagrams.

TABLE 3
Example 2

| | | | | | | | (N4-1)/ |
|---|---|---|---|---|---|---|---|
| Sn | R | D | N4 | N3 | N5 | Material | (N3-N5) |
| 1 | 32.9833 | 4.912 | 2.25182 | 2.25724 | 2.24618 | ZnS | 113.20 |
| 2 | 50.4133 | 1.199 | | | | | |
| 3 | 22.3391 | 6.396 | 1.34928 | 1.36647 | 1.32659 | LiF | 8.76 |
| 4 | 37.6722 | 2.925 | | | | | |
| 5 | 92.6876 | 2.472 | 1.34928 | 1.36647 | 1.32659 | LiF | 8.76 |
| 6 | 12.4173 | 4.324 | | | | | |
| 7 (St) | ∞ | 6.618 | | | | | |
| 8 | −15.8366 | 4.500 | 4.02506 | 4.04448 | 4.01628 | Ge | 107.29 |
| 9 | −20.5445 | 1.420 | | | | | |
| 10 | 46.3476 | 4.165 | 1.40964 | 1.41785 | 1.39896 | CaF2 | 21.68 |
| 11 | −26.3708 | 0.200 | | | | | |
| 12 | 38.6623 | 3.475 | 1.40964 | 1.41785 | 1.39896 | CaF2 | 21.68 |
| 13 | −48.5207 | 1.284 | | | | | |
| 14 | −34.1689 | 2.000 | 1.34928 | 1.36647 | 1.32659 | LiF | 8.76 |
| 15 | 120.9337 | 10.000 | | | | | |
| 16 | ∞ | 1.000 | 1.67524 | 1.71224 | 1.62397 | SAPPHIRE | 7.65 |
| 17 | ∞ | 17.404 | | | | | |

TABLE 4
Example 2

| | |
|---|---|
| f | 50.11 |
| Bf | 28.00 |
| FNo. | 2.02 |
| 2ω [°] | 20.2 |
| Y | 8.80 |

### Example 3

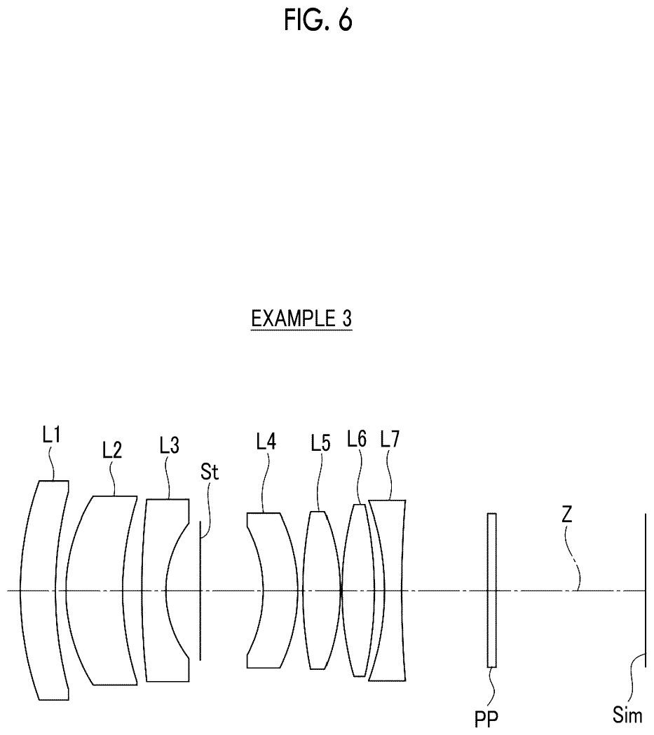

FIG. 6 is a cross-sectional view of a configuration of an imaging lens according to Example 3. The imaging lens according to Example 3 consists of lenses L1 to L3, an aperture stop St, and lenses L4 to L7, in order from the object side to the image side.

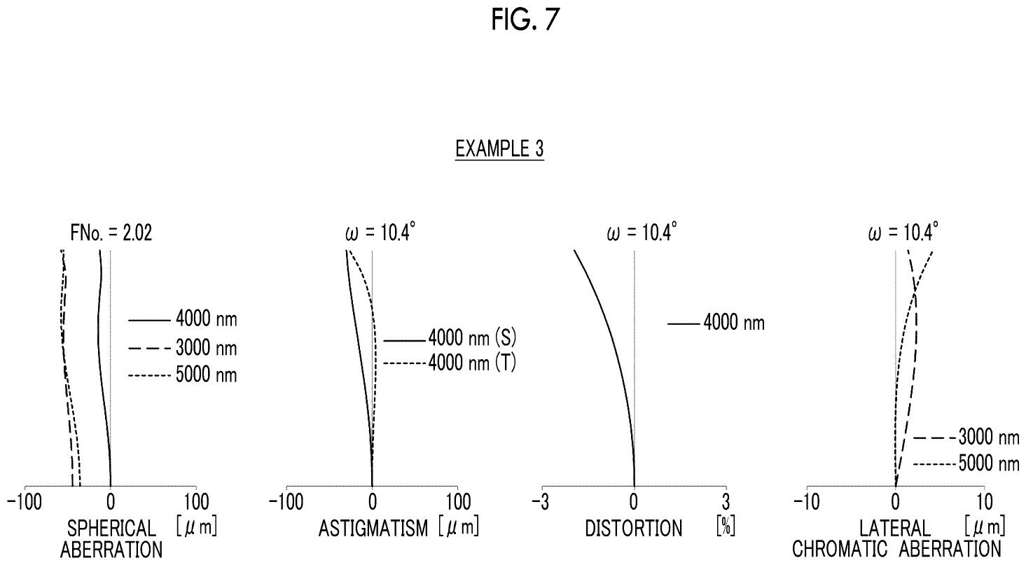

Regarding the imaging lens according to Example 3, Table 5 shows basic lens data, Table 6 shows specifications, and FIG. 7 shows aberration diagrams.

TABLE 5
Example 3

| | | | | | | | (N4-1)/ |
|---|---|---|---|---|---|---|---|
| Sn | R | D | N4 | N3 | N5 | Material | (N3-N5) |
| 1 | 37.9140 | 4.090 | 3.42530 | 3.43232 | 3.42207 | Si | 236.50 |
| 2 | 44.4279 | 1.229 | | | | | |
| 3 | 20.7164 | 6.600 | 1.34928 | 1.36647 | 1.32659 | LiF | 8.76 |
| 4 | 34.8590 | 2.228 | | | | | |
| 5 | 97.2149 | 2.800 | 1.34928 | 1.36647 | 1.32659 | LiF | 8.76 |
| 6 | 13.0109 | 4.000 | | | | | |
| 7 (St) | ∞ | 7.324 | | | | | |
| 8 | −16.0790 | 4.025 | 4.02506 | 4.04448 | 4.01628 | Ge | 107.29 |
| 9 | −20.4468 | 0.600 | | | | | |
| 10 | 47.5130 | 4.291 | 1.40964 | 1.41785 | 1.39896 | CaF2 | 21.68 |
| 11 | −24.6375 | 0.200 | | | | | |
| 12 | 36.8384 | 3.763 | 1.40964 | 1.41785 | 1.39896 | CaF2 | 21.68 |
| 13 | −45.5870 | 1.175 | | | | | |
| 14 | −30.8418 | 2.000 | 1.34928 | 1.36647 | 1.32659 | LiF | 8.76 |
| 15 | 128.6941 | 10.000 | | | | | |
| 16 | ∞ | 1.000 | 1.67524 | 1.71224 | 1.62397 | SAPPHIRE | 7.65 |
| 17 | ∞ | 17.405 | | | | | |

TABLE 6
Example 3

| | |
|---|---|
| f | 49.00 |
| Bf | 28.00 |
| FNo. | 2.02 |
| 2ω [°] | 20.8 |
| Y | 8.80 |

### Example 4

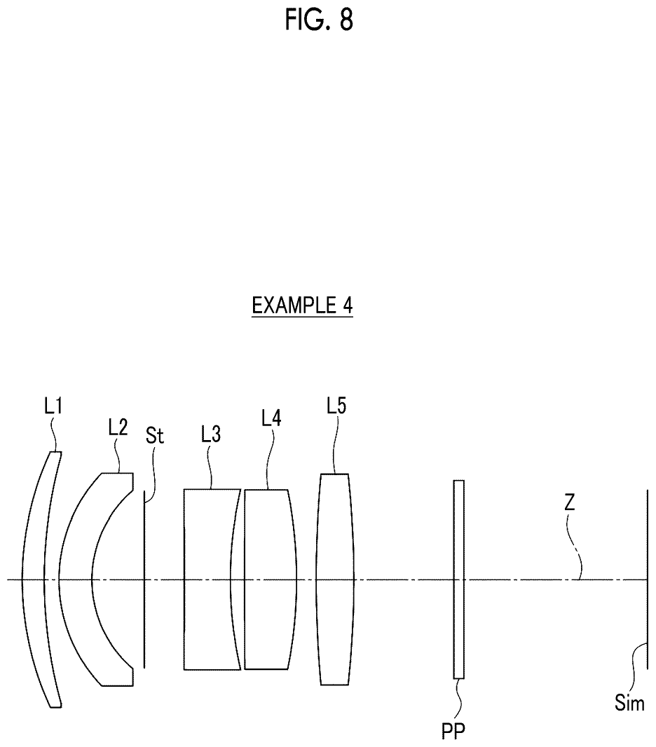

FIG. 8 is a cross-sectional view of a configuration of an imaging lens according to Example 4. The imaging lens according to Example 4 consists of lenses L1 and L2, an aperture stop St, and lenses L3 to L5, in order from the object side to the image side.

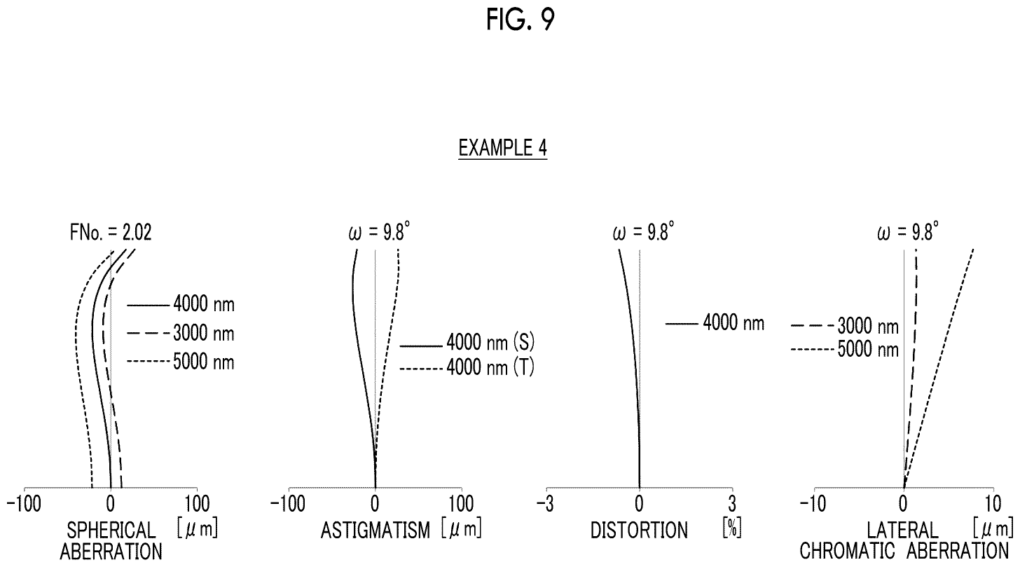

Regarding the imaging lens according to Example 4, Table 7 shows basic lens data, Table 8 shows specifications, and FIG. 9 shows aberration diagrams.

TABLE 7
Example 4

| | | | | | | | (N4-1)/ |
|---|---|---|---|---|---|---|---|
| Sn | R | D | N4 | N3 | N5 | Material | (N3-N5) |
| 1 | 30.3562 | 2.196 | 3.42530 | 3.43232 | 3.42207 | Si | 236.50 |
| 2 | 46.1439 | 1.468 | | | | | |
| 3 | 15.2747 | 3.290 | 1.34928 | 1.36647 | 1.32659 | LiF | 8.76 |
| 4 | 11.6970 | 5.236 | | | | | |
| 5 (St) | ∞ | 4.000 | | | | | |
| 6 | −1053.3537 | 4.600 | 4.02506 | 4.04448 | 4.01628 | Ge | 107.29 |
| 7 | 40.0509 | 1.416 | | | | | |
| 8 | 1250.0128 | 5.200 | 1.40964 | 1.41785 | 1.39896 | CaF2 | 21.68 |
| 9 | −45.2411 | 1.957 | | | | | |
| 10 | 115.7824 | 3.700 | 3.42530 | 3.43232 | 3.42207 | Si | 236.50 |
| 11 | −97.0331 | 10.000 | | | | | |
| 12 | ∞ | 1.000 | 1.67524 | 1.71224 | 1.62397 | SAPPHIRE | 7.65 |
| 13 | ∞ | 18.339 | | | | | |

TABLE 8
Example 4

| | |
|---|---|
| f | 51.22 |
| Bf | 28.94 |
| FNo. | 2.02 |
| 2ω [°] | 19.6 |
| Y | 8.80 |

### Example 5

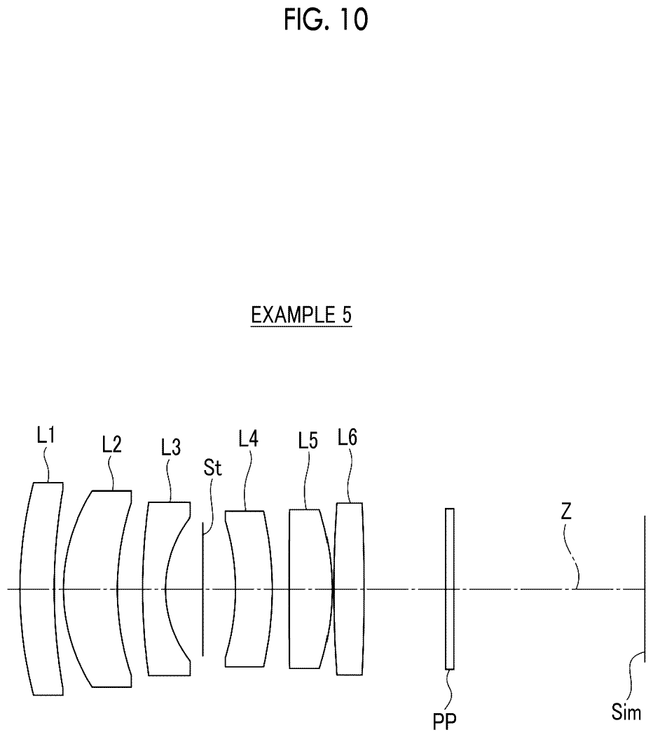

FIG. 10 is a cross-sectional view of a configuration of an imaging lens according to Example 5. The imaging lens according to Example 5 consists of lenses L1 to L3, an aperture stop St, and lenses L4 to L6, in order from the object side to the image side.

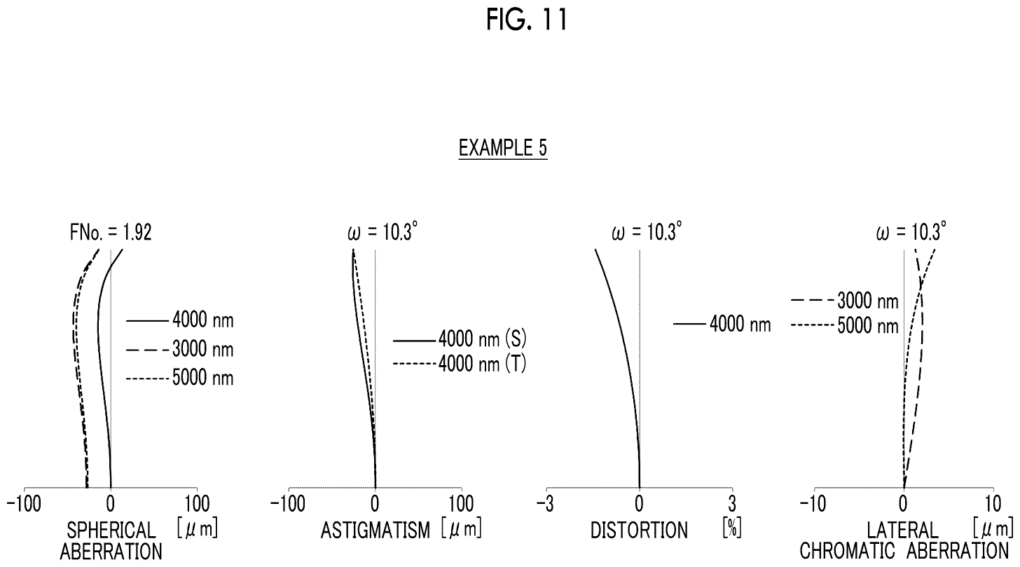

Regarding the imaging lens according to Example 5, Table 9 shows basic lens data, Table 10 shows specifications, and FIG. 11 shows aberration diagrams.

TABLE 9
Example 5

| | | | | | | | (N4-1)/ |
|---|---|---|---|---|---|---|---|
| Sn | R | D | N4 | N3 | N5 | Material | (N3-N5) |
| 1 | 51.0007 | 4.200 | 3.42530 | 3.43232 | 3.42207 | Si | 236.50 |
| 2 | 69.2373 | 1.135 | | | | | |
| 3 | 22.2322 | 6.600 | 1.34928 | 1.36647 | 1.32659 | LiF | 8.76 |
| 4 | 33.6020 | 3.100 | | | | | |
| 5 | 75.6456 | 2.800 | 1.34928 | 1.36647 | 1.32659 | LiF | 8.76 |
| 6 | 14.3214 | 4.574 | | | | | |
| 7 (St) | ∞ | 4.000 | | | | | |
| 8 | −28.7799 | 4.500 | 4.02506 | 4.04448 | 4.01628 | Ge | 107.29 |
| 9 | −42.9289 | 2.079 | | | | | |
| 10 | 1250.1691 | 5.200 | 1.40964 | 1.41785 | 1.39896 | CaF2 | 21.68 |
| 11 | −31.4493 | 0.200 | | | | | |
| 12 | 145.5475 | 3.700 | 3.42530 | 3.43232 | 3.42207 | Si | 236.50 |
| 13 | −221.8465 | 10.000 | | | | | |
| 14 | ∞ | 1.000 | 1.67524 | 1.71224 | 1.62397 | SAPPHIRE | 7.65 |
| 15 | ∞ | 23.403 | | | | | |

TABLE 10
Example 5

| | |
|---|---|
| f | 49.00 |
| Bf | 34.00 |
| FNo. | 1.92 |
| 2ω [°] | 20.6 |
| Y | 8.80 |

### Example 6

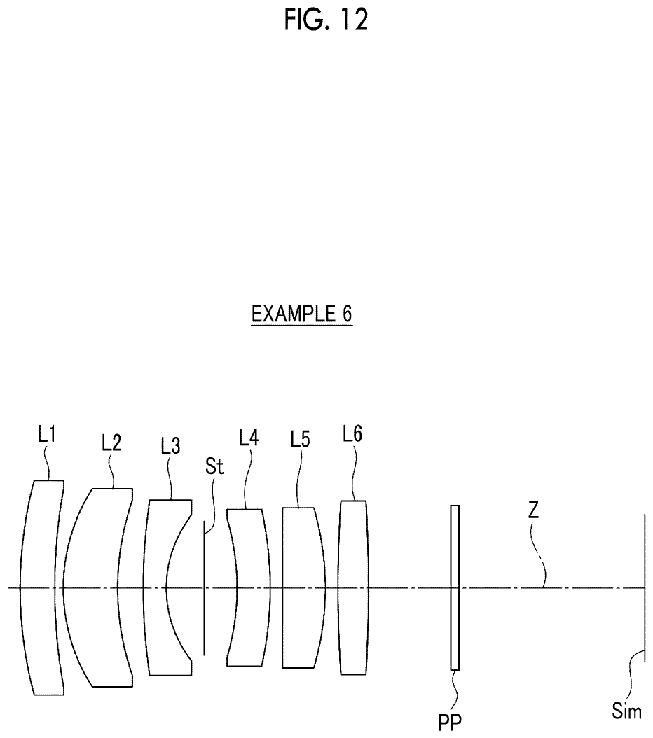

FIG. 12 is a cross-sectional view of a configuration of an imaging lens according to Example 6. The imaging lens according to Example 6 consists of lenses L1 to L3, an aperture stop St, and lenses L4 to L6, in order from the object side to the image side.

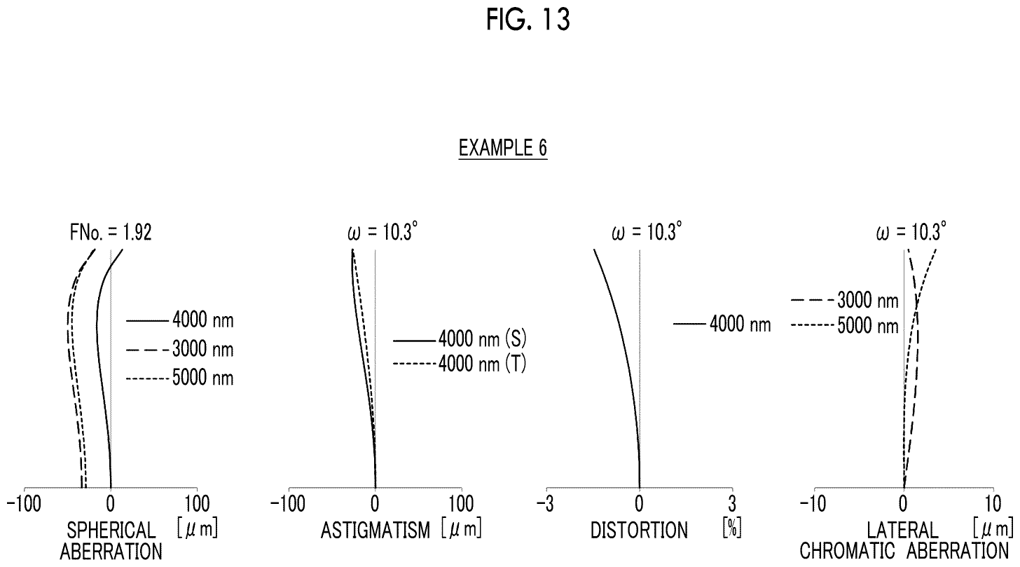

Regarding the imaging lens according to Example 6, Table 11 shows basic lens data, Table 12 shows specifications, and FIG. 13 shows aberration diagrams. In the table of basic lens data, the abbreviation of the manufacturing company of the material is noted in parentheses under the material name “K-FIR98UV”. “Sumita Optics” indicates Sumita Optical Industries Ltd. Similarly, in the “Material” column of the table of the basic lens data of the following examples, the abbreviation or name of the manufacturing company of the material is noted in parentheses under a part of the material name.

TABLE 11
Example 6

| | | | | | | | (N4-1)/ |
|---|---|---|---|---|---|---|---|
| Sn | R | D | N4 | N3 | N5 | Material | (N3-N5) |
| 1 | 50.2023 | 4.200 | 3.42530 | 3.43232 | 3.42207 | Si | 236.50 |
| 2 | 68.0175 | 1.036 | | | | | |
| 3 | 22.1795 | 6.600 | 1.34928 | 1.36647 | 1.32659 | LiF | 8.76 |
| 4 | 32.4853 | 3.100 | | | | | |
| 5 | 71.3756 | 2.800 | 1.34928 | 1.36647 | 1.32659 | LiF | 8.76 |
| 6 | 14.2663 | 4.590 | | | | | |
| 7 (St) | ∞ | 4.000 | | | | | |
| 8 | −29.8848 | 4.019 | 4.02506 | 4.04448 | 4.01628 | Ge | 107.29 |
| 9 | −44.1404 | 1.489 | | | | | |
| 10 | 1250.2118 | 5.200 | 1.39824 | 1.40787 | 1.38585 | K-FIR98UV | 18.09 |
| | | | | | | (Sumita | |
| | | | | | | Optics) | |
| 11 | −34.2892 | 1.469 | | | | | |
| 12 | 157.7335 | 3.700 | 3.42530 | 3.43232 | 3.42207 | Si | 236.50 |
| 13 | −174.0349 | 10.000 | | | | | |
| 14 | ∞ | 1.000 | 1.67524 | 1.71224 | 1.62397 | SAPPHIRE | 7.65 |
| 15 | ∞ | 22.530 | | | | | |

TABLE 12
Example 6

| | |
|---|---|
| f | 49.00 |
| Bf | 33.13 |
| FNo. | 1.92 |
| 2ω [°] | 20.6 |
| Y | 8.80 |

### Example 7

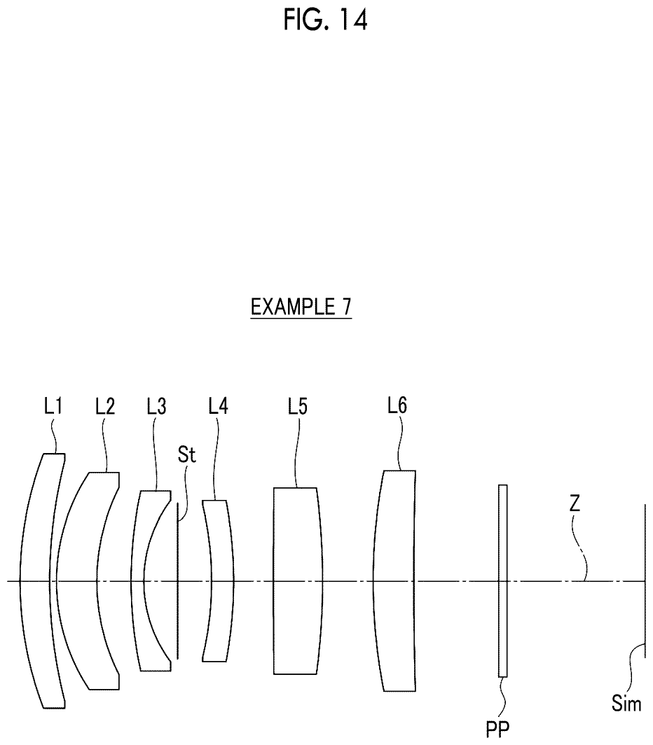

FIG. 14 is a cross-sectional view of a configuration of an imaging lens according to Example 7. The imaging lens according to Example 7 consists of lenses L1 to L3, an aperture stop St, and lenses L4 to L6, in order from the object side to the image side.

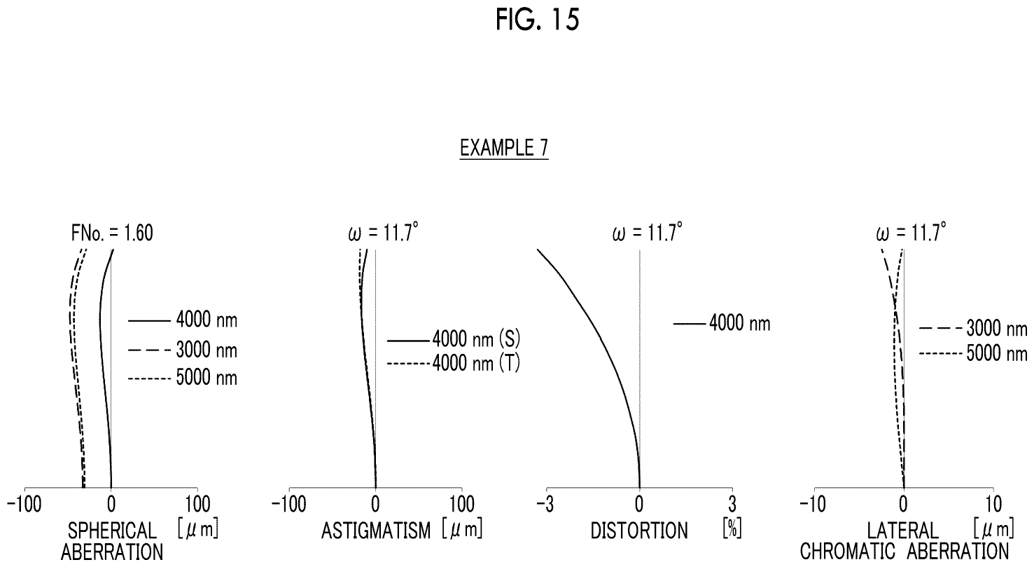

Regarding the imaging lens according to Example 7, Table 13 shows basic lens data, Table 14 shows specifications, and FIG. 15 shows aberration diagrams.

TABLE 13
Example 7

| | | | | | | | (N4-1)/ |
|---|---|---|---|---|---|---|---|
| Sn | R | D | N4 | N3 | N5 | Material | (N3-N5) |
| 1 | 42.0152 | 3.500 | 3.42530 | 3.43232 | 3.42207 | Si | 236.50 |
| 2 | 57.3756 | 0.800 | | | | | |
| 3 | 23.0702 | 4.765 | 1.34928 | 1.36647 | 1.32659 | LiF | 8.76 |
| 4 | 24.5635 | 4.041 | | | | | |
| 5 | 49.8083 | 1.500 | 1.38652 | 1.39643 | 1.37374 | K-FIR100UV | 17.04 |
| | | | | | | (Sumita | |
| | | | | | | Optics) | |
| 6 | 15.8768 | 4.000 | | | | | |
| 7 (St) | ∞ | 4.000 | | | | | |
| 8 | −38.8222 | 2.600 | 4.02506 | 4.04448 | 4.01628 | Ge | 107.29 |
| 9 | −50.8044 | 4.700 | | | | | |
| 10 | 1250.5668 | 5.800 | 1.40964 | 1.41785 | 1.39896 | CaF2 | 21.68 |
| 11 | −83.4491 | 5.900 | | | | | |
| 12 | 66.8845 | 4.800 | 3.42530 | 3.43232 | 3.42207 | Si | 236.50 |
| 13 | 460.3712 | 10.000 | | | | | |
| 14 | ∞ | 1.000 | 1.39824 | 1.40787 | 1.38585 | K-FIR98UV | 18.09 |
| | | | | | | (Sumita | |
| | | | | | | Optics) | |
| 15 | ∞ | 16.286 | | | | | |

TABLE 14
Example 7

| | |
|---|---|
| f | 43.87 |
| Bf | 27.00 |
| FNo. | 1.60 |
| 2ω [°] | 23.4 |
| Y | 8.80 |

### Example 8

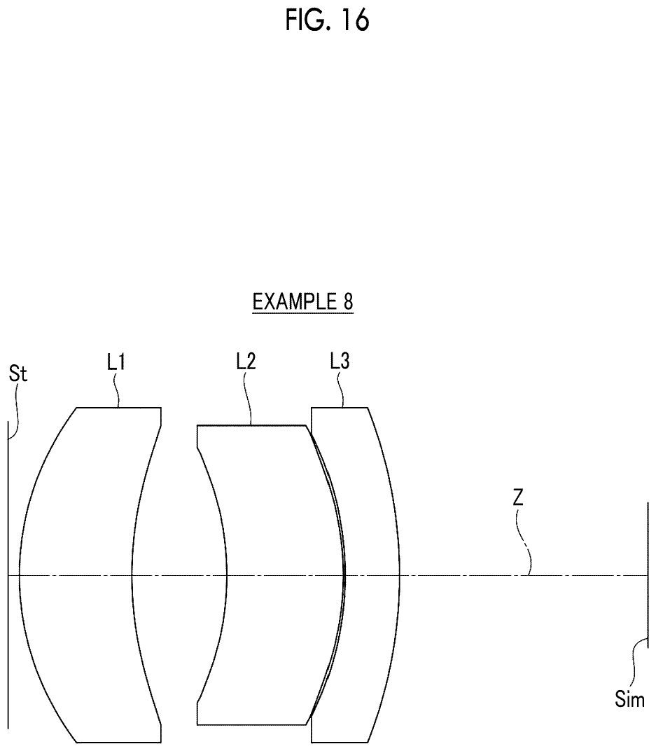

FIG. 16 is a cross-sectional view of a configuration of the imaging lens according to Example 8. The imaging lens according to Example 8 consists of an aperture stop St and lenses L1 to L3, in order from the object side to the image side.

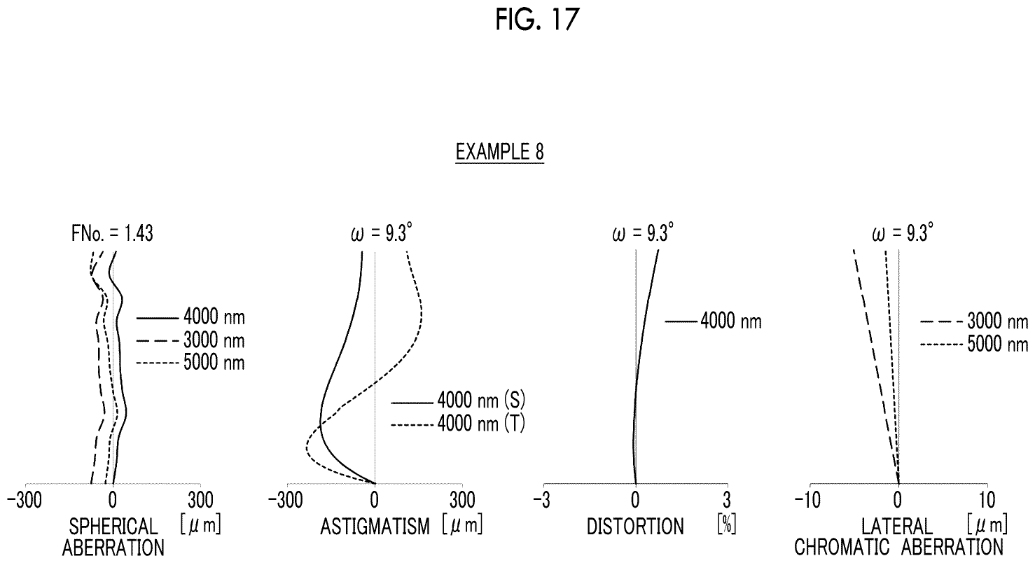

The imaging lens according to Example 8 includes an aspherical lens. Regarding the imaging lens according to Example 8, Table 15 shows basic lens data, Table 16 shows specifications, Table 17 shows aspherical coefficients thereof, and FIG. 17 shows aberration diagrams.

In basic lens data, a reference sign * is attached to surface numbers of aspherical surfaces, and values of the paraxial curvature radius are written into the column of the curvature radius of the aspherical surface. In Table 17, the Sn row shows surface numbers of the aspherical surfaces, and the KA and Am rows show numerical values of the aspherical coefficients for each aspherical surface. It should be noted that m of Am is an integer of 3 or more and 20 or less (m=3, 4, 5, . . . , and 20). The “E±n” (n: an integer) in numerical values of the aspherical coefficients of Table 17 indicates “×10^{±n}”. KA and Am are the aspherical coefficients in the aspherical surface expression represented by the following expression.

$$Zd = C \times {h}^{2} / \{ 1 + {( 1 - KA \times {C}^{2} \times {h}^{2} )}^{1 / 2} \} + \sum Am \times {h}^{m}$$

Here,
Zd is the aspherical depth (length of a perpendicular line drawn from a point on the aspherical surface at height h to a plane perpendicular to the optical axis Z in contact with the aspherical apex),
h is the height (distance from the optical axis Z to the lens surface),
C is the reciprocal of paraxial curvature radius,
KA and Am are aspherical coefficients, and
Σ in the aspherical equation means the sum of m.

The description method for the above-mentioned aspherical surface is the same for other examples in which the aspherical surfaces are provided.

TABLE 15
Example 7

| | | | | | | | (N4-1)/ |
|---|---|---|---|---|---|---|---|
| Sn | R | D | N4 | N3 | N5 | Material | (N3-N5) |
| 1 (st) | ∞ | 1.221 | | | | | |
| *2 | 32.2911 | 12.229 | 2.51329 | 2.51803 | 2.51029 | IRG22 | 195.34 |
| | | | | | | (SCHOTT) | |
| *3 | 43.3522 | 10.316 | | | | | |
| *4 | −33.8530 | 12.595 | 2.80342 | 2.81105 | 2.79934 | IRG23 | 153.98 |
| | | | | | | (SCHOTT) | |
| *5 | −33.6169 | 0.200 | | | | | |
| 6 | −37.2682 | 5.911 | 1.40964 | 1.41785 | 1.39896 | CAF2 | 21.68 |
| 7 | −53.6752 | 27.000 | | | | | |

TABLE 16
Example 7

| | |
|---|---|
| f | 49.88 |
| Bf | 27.00 |
| FNo. | 1.4 |
| 2ω [°] | 18.6 |
| Y | 8.20 |

TABLE 17
Example 8

| Sn | 2 | 3 | 4 | 5 |
|---|---|---|---|---|
| KA | 1.0000000E+00 | 1.0000000E+00 | 1.0000000E+00 | 1.0000000E+00 |
| A3 | −1.5827631E−05 | 5.6748214E−05 | 3.9076835E−04 | 1.2206117E−04 |
| A4 | 2.2637054E−06 | −1.2316694E−05 | −2.2013268E−04 | −3.2750984E−05 |
| A5 | 6.5634735E−06 | −2.2662628E−06 | 1.0145570E−05 | −5.8766550E−06 |
| A6 | −3.4459713E−06 | 1.8772667E−06 | 3.7648058E−05 | 6.0133781E−06 |
| A7 | 8.1748977E−07 | −4.6774411E−07 | −1.8354653E−05 | −1.4778218E−06 |
| A8 | −1.1575347E−07 | 6.1592096E−08 | 4.2288504E−06 | 1.4229483E−07 |
| A9 | 1.1207907E−08 | −4.5048586E−09 | −5.3303605E−07 | 4.6938592E−09 |
| A10 | −7.9388977E−10 | 1.6481138E−10 | 3.0903896E−08 | −2.4952010E−09 |
| A11 | 3.3823367E−11 | −2.7586638E−12 | 7.5143881E−10 | 2.2167541E−10 |
| A12 | 6.0574823E−13 | 1.2801854E−13 | −2.6669220E−10 | −1.4209046E−12 |
| A13 | −1.9106659E−13 | −5.7750961E−15 | 2.0949541E−11 | −1.2528295E−12 |
| A14 | 9.0026329E−15 | 3.8067591E−16 | −8.4382365E−13 | 1.0777232E−13 |
| A15 | 1.0657925E−16 | −7.2355746E−17 | −1.6427506E−15 | −3.5705629E−15 |
| A16 | −2.0172704E−17 | −7.4596781E−20 | 3.4370420E−15 | −2.8855633E−18 |
| A17 | 1.4966238E−19 | 5.4395155E−19 | −2.4783656E−16 | 1.6337579E−18 |
| A18 | 3.4824929E−20 | −2.7013942E−20 | 5.9801742E−18 | 1.8610931E−19 |
| A19 | −1.3263470E−21 | 1.8287589E−22 | 6.9921503E−20 | −1.2985405E−20 |
| A20 | 1.5186145E−23 | 8.0171163E−24 | −3.9691269E−21 | 2.3198847E−22 |

### Example 9

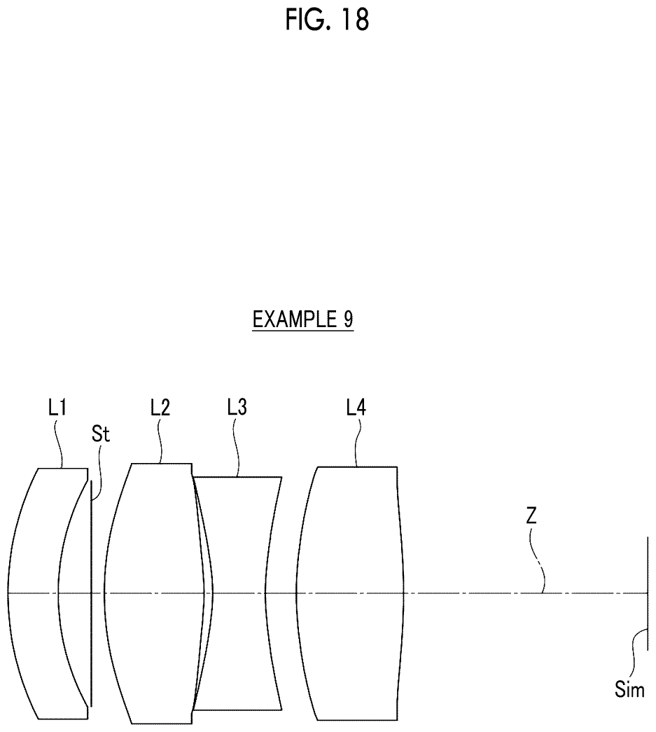

FIG. 18 is a cross-sectional view of a configuration of the imaging lens according to Example 9. The imaging lens according to Example 9 consists of a lens L1, an aperture stop St, and lenses L2 to L4, in order from the object side to the image side.

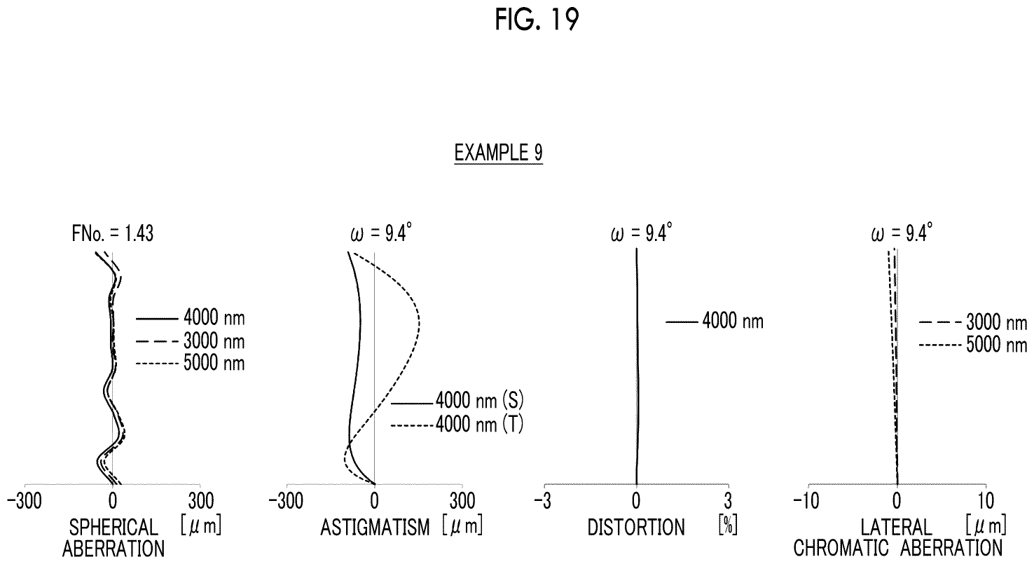

Regarding the imaging lens according to Example 9, Table 18 shows basic lens data, Table 19 shows specifications, Table 20 shows aspherical coefficients thereof, and FIG. 19 shows aberration diagrams.

TABLE 18
Example 9

| | | | | | | | (N4-1)/ |
|---|---|---|---|---|---|---|---|
| Sn | R | D | N4 | N3 | N5 | Material | (N3-N5) |
| 1 | 41.7031 | 7.027 | 1.40964 | 1.41785 | 1.39896 | CAF2 | 21.68 |
| 2 | 35.4222 | 4.618 | | | | | |
| 3 (St) | ∞ | 1.816 | | | | | |
| *4 | 46.1250 | 13.856 | 2.51329 | 2.51803 | 2.51029 | IRG22 | 195.34 |
| | | | | | | (SCHOTT) | |
| *5 | −29.2217 | 1.209 | | | | | |
| *6 | −22.4877 | 7.365 | 2.80342 | 2.81105 | 2.79934 | IRG23 | 153.98 |
| | | | | | | (SCHOTT) | |
| *7 | 39.0767 | 4.319 | | | | | |
| *8 | 44.7046 | 15.000 | 2.51329 | 2.51803 | 2.51029 | IRG22 | 195.34 |
| | | | | | | (SCHOTT) | |
| *9 | −92.0202 | 34.043 | | | | | |

TABLE 19
Example 9

| | |
|---|---|
| f | 49.79 |
| Bf | 34.04 |
| FNo. | 1.4 |
| 2ω [°] | 18.8 |
| Y | 8.20 |

TABLE 20
Example 9

| Sn | 4 | 5 | 6 |
|---|---|---|---|
| KA | 1.0000000E+00 | 1.0000000E+00 | 1.0000000E+00 |
| A3 | 4.0142956E−06 | 7.7582715E−04 | 1.0871765E−03 |
| A4 | 2.9553300E−05 | 7.8118947E−05 | 4.5410586E−05 |
| A5 | −1.0995508E−05 | −1.6343632E−06 | 1.9590193E−06 |
| A6 | 1.6777057E−06 | 6.8868555E−07 | 8.0319282E−07 |
| A7 | −8.1589621E−08 | −5.0733839E−07 | −5.7771469E−07 |
| A8 | −4.6585709E−09 | 8.7342312E−08 | 4.8032698E−08 |
| A9 | 1.2700293E−10 | −6.9643551E−09 | 2.2381706E−09 |
| A10 | 1.0271351E−10 | 2.1880154E−10 | −2.9514142E−10 |
| A11 | −1.1097641E−11 | 3.6336808E−14 | −4.6445474E−12 |
| A12 | 5.9173645E−13 | 4.0280470E−13 | 3.8660576E−13 |
| A13 | −4.2819181E−14 | −3.3481853E−14 | 5.4882040E−14 |
| A14 | 2.6436135E−15 | 9.2192652E−17 | −1.0664552E−15 |
| A15 | 3.0965988E−17 | −1.4141080E−16 | −1.1883028E−16 |
| A16 | −1.0987587E−17 | 1.3762348E−17 | 1.3769863E−18 |
| A17 | 2.6712683E−19 | −8.1090425E−20 | −5.9810349E−19 |
| A18 | 1.3751982E−20 | −4.0007975E−21 | 8.3902790E−20 |
| A19 | −7.3465590E−22 | −9.6521004E−22 | −3.4597836E−21 |
| A20 | 9.4092702E−24 | 3.2546808E−23 | 4.6831197E−23 |

| Sn | 7 | 8 |
|---|---|---|
| KA | 1.0000000E+00 | 1.0000000E+00 |
| A3 | 4.8090872E−04 | 3.8109317E−04 |
| A4 | −2.2913530E−04 | −2.3615066E−04 |
| A5 | 2.3143380E−05 | 3.4678614E−05 |
| A6 | 4.3928646E−06 | 3.2350482E−06 |
| A7 | −1.6493892E−06 | −2.0595958E−06 |
| A8 | 1.2837098E−07 | 3.3018730E−07 |
| A9 | 7.0854450E−09 | −2.9203863E−08 |
| A10 | −9.9756308E−10 | 1.9947297E−09 |
| A11 | −3.4027308E−11 | −1.2524763E−10 |
| A12 | 4.4285956E−12 | 4.9494276E−12 |
| A13 | 3.1446917E−13 | −3.2086811E−14 |
| A14 | −3.5369179E−14 | 4.3782404E−16 |
| A15 | 3.5677444E−16 | −3.0054528E−16 |
| A16 | 2.8255733E−17 | −1.1182602E−17 |
| A17 | 1.9324181E−18 | 1.9482228E−18 |
| A18 | −2.1127111E−19 | −3.4886545E−20 |
| A19 | 6.2984497E−21 | −1.5289996E−21 |
| A20 | −6.7492445E−23 | 4.3100574E−23 |

### Example 10

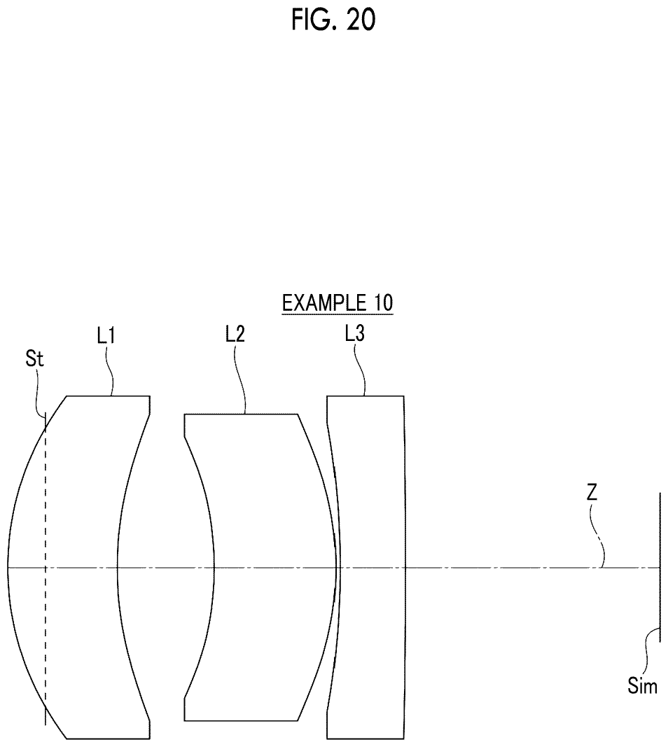

FIG. 20 is a cross-sectional view of a configuration of the imaging lens according to Example 10. The imaging lens according to Example 10 consists of an aperture stop St and lenses L1 to L3.

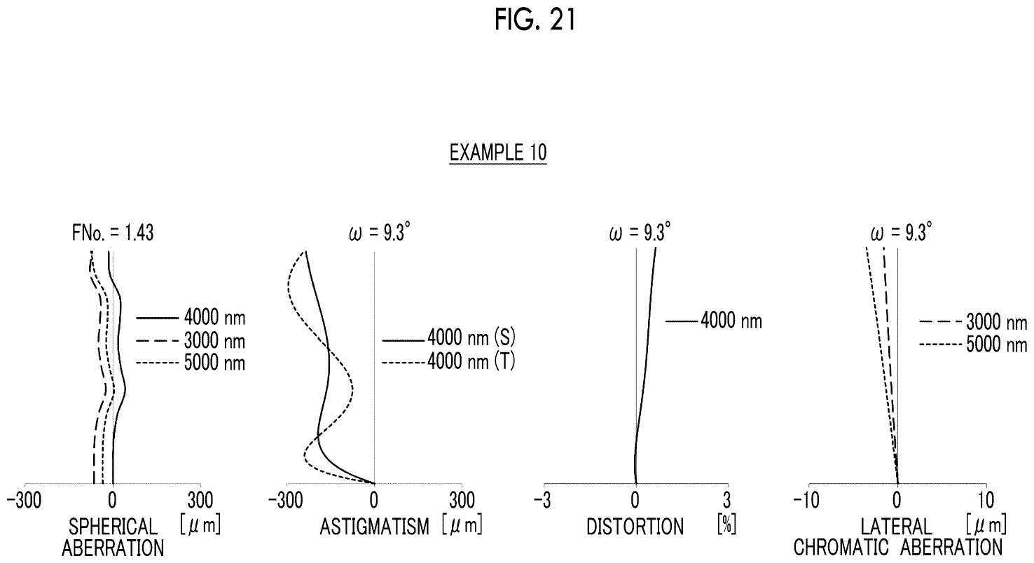

Regarding the imaging lens according to Example 10, Table 21 shows basic lens data, Table 22 shows specifications, Table 23 shows aspherical coefficients thereof, and FIG. 21 shows aberration diagrams. “Chengdu Guangming” in the basic lens data indicates Chengdu Guangming Optoelectronics Co., Ltd.

TABLE 21
Example 10

| | | | | | | | (N4-1)/ |
|---|---|---|---|---|---|---|---|
| Sn | R | D | N4 | N3 | N5 | Material | (N3-N5) |
| 1 (st) | ∞ | −4.000 | | | | | |
| *2 | 32.0939 | 11.609 | 2.50998 | 2.51451 | 2.50712 | HWS4 | 204.44 |
| | | | | | | (Chengdu | |
| | | | | | | Guangming) | |
| *3 | 40.6675 | 10.278 | | | | | |
| *4 | −36.5997 | 12.875 | 2.79468 | 2.80146 | 2.79088 | IRG26 | 169.55 |
| | | | | | | (SCHOTT) | |
| *5 | −34.3917 | 0.439 | | | | | |
| 6 | −95.9269 | 6.914 | 1.40964 | 1.41785 | 1.39896 | CAF2 | 21.68 |
| 7 | −1024.5311 | 26.996 | | | | | |

TABLE 22
Example 10

| | |
|---|---|
| f | 49.80 |
| Bf | 27.00 |
| FNo. | 1.4 |
| 2ω [°] | 18.6 |
| Y | 8.20 |

TABLE 23
Example 10

| Sn | 2 | 3 | 4 | 5 |
|---|---|---|---|---|
| KA | 1.0000000E+00 | 1.0000000E+00 | 1.0000000E+00 | 1.0000000E+00 |
| A3 | −7.3208343E−06 | 9.2910802E−05 | 4.4319842E−04 | 1.0492985E−04 |
| A4 | 2.5156327E−06 | −3.4003864E−05 | −2.7329425E−04 | 2.2469869E−05 |
| A5 | 3.6308052E−06 | 6.2931397E−06 | 8.8110820E−05 | −2.7600688E−05 |
| A6 | −1.7890142E−06 | −2.8322771E−07 | −1.5385649E−05 | 8.3122196E−06 |
| A7 | 3.5355786E−07 | −1.0327481E−07 | 6.6972090E−07 | −1.2012897E−06 |
| A8 | −3.5878710E−08 | 1.9531843E−08 | 1.7408895E−07 | 8.2733019E−08 |
| A9 | 1.8532381E−09 | −1.1288137E−09 | −8.3831900E−09 | −1.1175097E−09 |
| A10 | −3.5343055E−11 | −2.4596923E−11 | −5.9008832E−09 | −1.6700543E−10 |
| A11 | −7.1781129E−13 | 4.2936434E−12 | 1.0536271E−09 | 7.4507532E−12 |
| A12 | 5.2519800E−14 | 7.5777152E−15 | −6.9461465E−11 | −1.0535684E−13 |
| A13 | 5.2805600E−16 | −8.0443099E−15 | 2.0199066E−12 | −2.6177411E−14 |
| A14 | −2.4663717E−16 | 2.9365938E−16 | −1.7690382E−13 | 6.4072103E−15 |
| A15 | −8.8047392E−18 | −4.2844863E−17 | 2.6601951E−14 | −3.0661113E−16 |
| A16 | 2.1367212E−18 | −8.2810308E−20 | −2.0051735E−15 | −1.4956970E−17 |
| A17 | −2.2493631E−21 | 2.3501666E−19 | 1.1881921E−16 | 1.1684340E−18 |
| A18 | −9.2700705E−21 | 2.2724442E−21 | −7.1799987E−18 | 3.0932570E−20 |
| A19 | 4.3051741E−22 | −9.9303614E−22 | 2.9144056E−19 | −3.6853407E−21 |
| A20 | −6.0572094E−24 | 2.6065836E−23 | −4.8641766E−21 | 7.2109984E−23 |

### Example 11

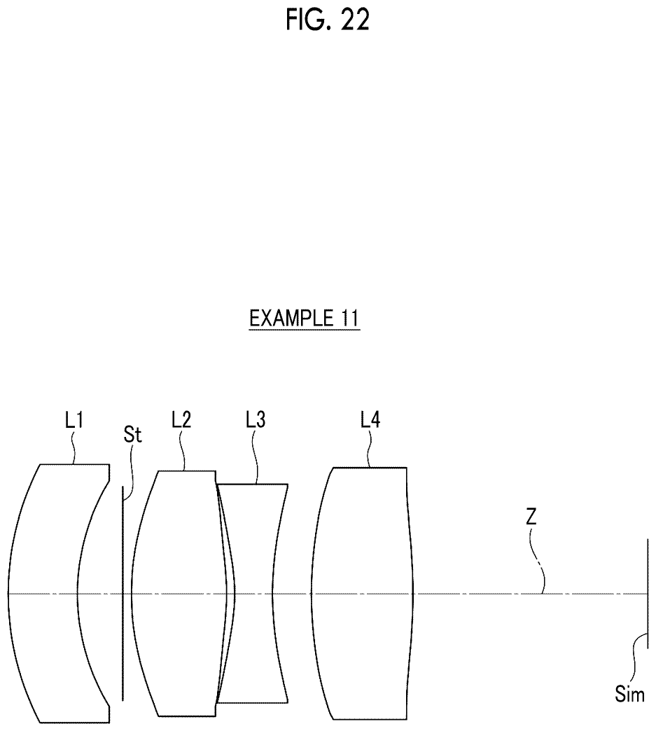

FIG. 22 is a cross-sectional view of a configuration of the imaging lens according to Example 11. The imaging lens according to Example 11 consists of a lens L1, an aperture stop St, and lenses L2 to L4, in order from the object side to the image side.

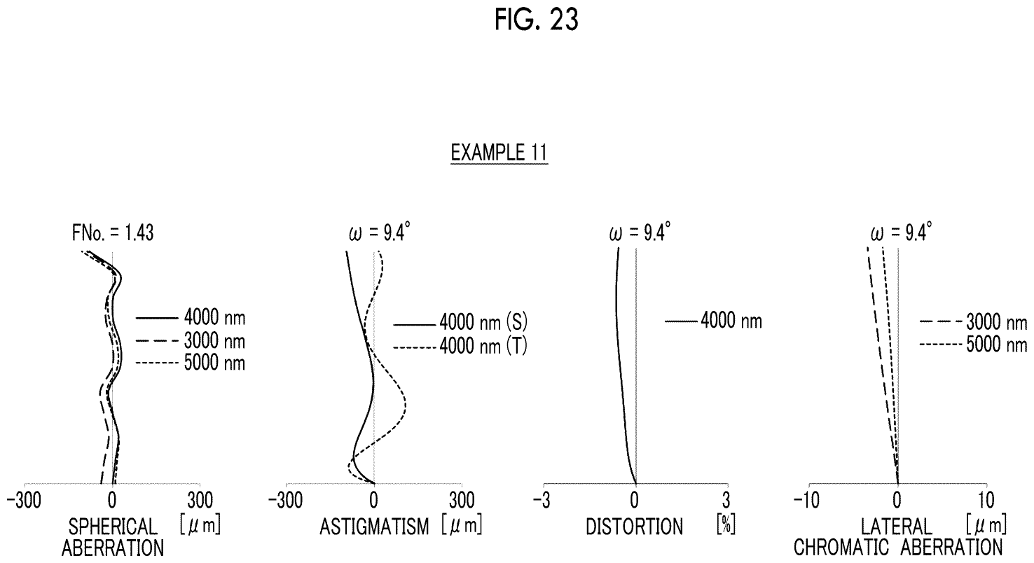

Regarding the imaging lens according to Example 11, Table 24 shows basic lens data, Table 25 shows specifications, Table 26 shows aspherical coefficients thereof, and FIG. 23 shows aberration diagrams.

TABLE 24
Example 11

| | | | | | | | (N4-1)/ |
|---|---|---|---|---|---|---|---|
| Sn | R | D | N4 | N3 | N5 | Material | (N3-N5) |
| 1 | 43.7405 | 10.000 | 1.40964 | 1.41785 | 1.39896 | CAF2 | 21.68 |
| 2 | 33.7029 | 6.563 | | | | | |
| 3(St) | ∞ | 1.261 | | | | | |
| *4 | 44.1700 | 13.680 | 2.51329 | 2.51803 | 2.51029 | IRG22 | 195.34 |
| | | | | | | (SCHOTT) | |
| *5 | −28.8527 | 1.167 | | | | | |
| *6 | −22.8205 | 5.458 | 2.79465 | 2.80151 | 2.79080 | HWS6 | 167.54 |
| | | | | | | (Chengdu | |
| | | | | | | Guangming) | |
| *7 | 42.6098 | 5.637 | | | | | |
| *8 | 54.5654 | 14.687 | 2.51324 | 2.51840 | 2.51017 | HWS3 | 183.96 |
| | | | | | | (Chengdu | |
| | | | | | | Guangming) | |
| *9 | −91.4290 | 33.910 | | | | | |

TABLE 25
Example 11

| | |
|---|---|
| f | 49.85 |
| Bf | 33.91 |
| FNo. | 1.4 |
| 2ω [°] | 18.8 |
| Y | 8.20 |

TABLE 26
Example 11

| Sn | 4 | 5 | 6 | 7 |
|---|---|---|---|---|
| KA | 1.0000000E+00 | 1.0000000E+00 | 1.0000000E+00 | 1.0000000E+00 |
| A3 | 3.6716249E−05 | 5.5438037E−04 | 7.9649703E−04 | 8.1082869E−04 |
| A4 | 1.9963907E−05 | 1.4866012E−04 | 8.8018854E−05 | −5.9399562E−04 |
| A5 | −1.0467922E−05 | 1.8299990E−05 | 1.7000390E−05 | 1.4458733E−04 |
| A6 | 2.2965273E−06 | −9.4866207E−06 | −7.9063932E−06 | −1.9275776E−05 |
| A7 | −1.2122363E−07 | 7.9899756E−07 | 7.0410564E−07 | 1.5568705E−06 |
| A8 | −3.5590459E−08 | 4.5798837E−08 | 3.0062019E−08 | −1.4753811E−07 |
| A9 | 5.8842753E−09 | −9.0279119E−09 | −6.7561407E−09 | 1.7942430E−08 |
| A10 | −1.4659422E−10 | 2.1462705E−10 | 1.6004938E−10 | −3.1167685E−10 |
| A11 | −2.5575200E−11 | 4.1074280E−12 | 2.3557896E−12 | −1.7089699E−10 |
| A12 | 9.3923614E−13 | 1.0747498E−12 | 8.7782237E−13 | 9.3215430E−12 |
| A13 | 1.2420086E−13 | 2.8743571E−14 | 2.0796693E−14 | 8.2540401E−13 |
| A14 | −6.7279242E−15 | −1.0248854E−14 | −7.7922202E−15 | −6.8221371E−14 |
| A15 | −1.7620888E−16 | −6.8757784E−17 | −3.2668062E−17 | −1.0161934E−15 |
| A16 | 9.4739081E−18 | 2.8383505E−17 | 2.1022494E−17 | 1.2618013E−16 |
| A17 | 6.4860599E−19 | 5.2519691E−19 | 2.7745940E−19 | 4.7364984E−18 |
| A18 | −3.2452352E−20 | −5.2305351E−20 | −3.6495108E−20 | −3.3188945E−19 |
| A19 | 1.3015258E−24 | −1.2231334E−21 | −6.2445048E−22 | −1.7328703E−21 |
| A20 | 1.1842235E−23 | 6.5342653E−23 | 3.8786139E−23 | 2.1291080E−22 |

| Sn | 8 | 9 |
|---|---|---|
| KA | 1.0000000E+00 | 1.0000000E+00 |
| A3 | 4.4644915E−04 | 6.6458361E−05 |
| A4 | −2.8748433E−04 | −3.0005937E−06 |
| A5 | 5.3777355E−05 | −2.0881274E−05 |
| A6 | −4.9790533E−06 | 6.4369744E−06 |
| A7 | 4.1882505E−07 | −3.7654336E−07 |
| A8 | −8.6772149E−08 | −1.0242247E−07 |
| A9 | 1.1414823E−08 | 1.6975740E−08 |
| A10 | −2.5633918E−10 | −4.1191714E−10 |
| A11 | −6.1260272E−11 | −7.3403683E−11 |
| A12 | 2.7419659E−12 | 2.6687929E−12 |
| A13 | 2.6616648E−13 | 3.5068757E−13 |
| A14 | −1.7768605E−14 | −1.8982155E−14 |
| A15 | −2.8851280E−16 | −4.8969170E−16 |
| A16 | 2.5778248E−17 | 2.6446551E−17 |
| A17 | 1.1953738E−18 | 1.8105386E−18 |
| A18 | −7.6633030E−20 | −9.1129797E−20 |
| A19 | 4.0576700E−22 | 6.9196091E−23 |
| A20 | 2.0336770E−23 | 3.1192519E−23 |

### Example 12

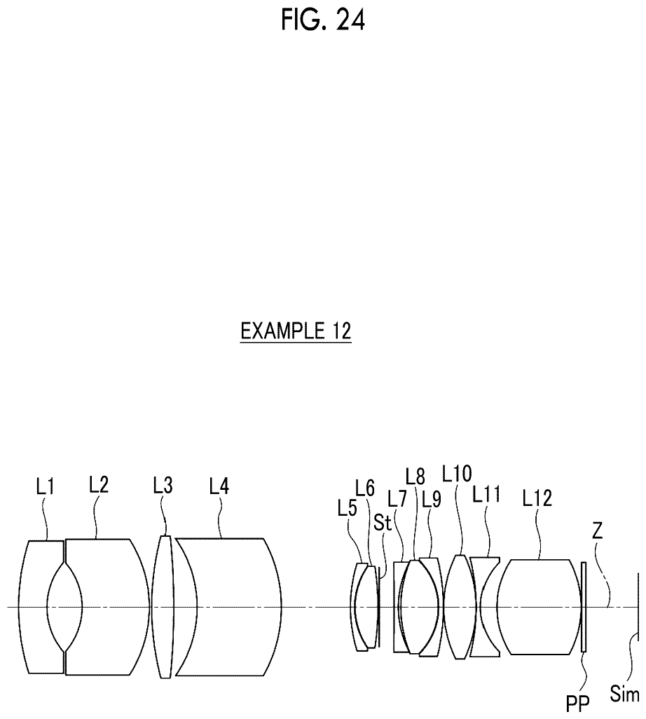

FIG. 24 is a cross-sectional view of a configuration of the imaging lens according to Example 12. The imaging lens according to Example 12 consists of lenses L1 to L6, an aperture stop St, and lenses L7 to L12, in order from the object side to the image side.

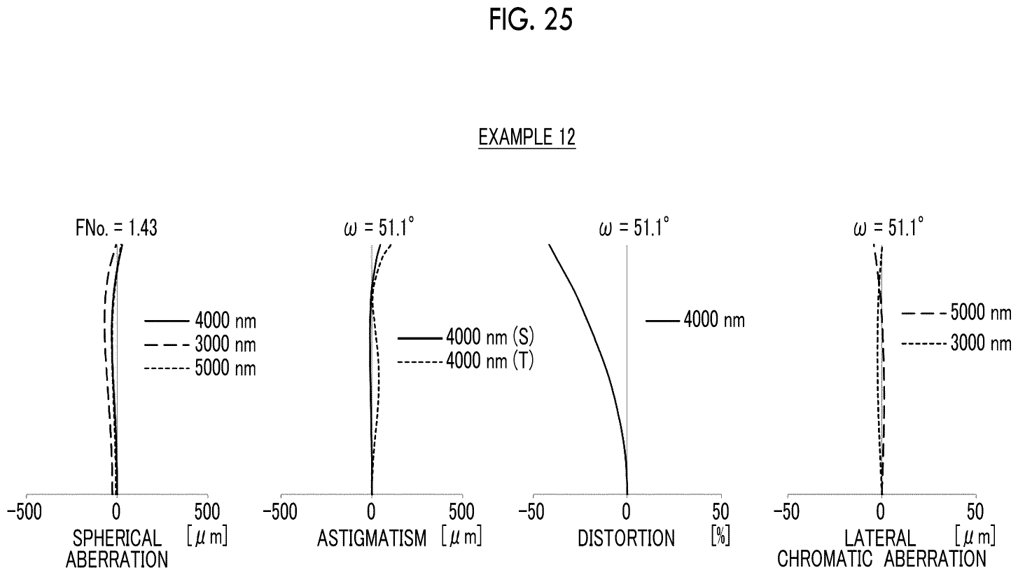

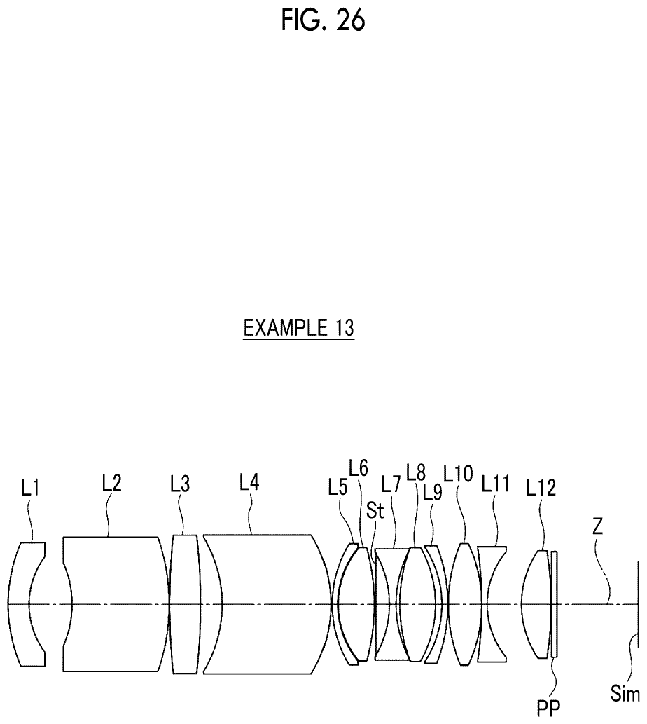

Regarding the imaging lens according to Example 12, Table 27 shows basic lens data, Table 28 shows specifications, and FIG. 25 shows aberration diagrams.

TABLE 27
Example 12

| | | | | | | | (N4-1)/ |
|---|---|---|---|---|---|---|---|
| Sn | R | D | N4 | N3 | N5 | Material | (N3-N5) |
| 1 | 52.8754 | 6.733 | 2.25247 | 2.25800 | 2.24658 | ZnS | 109.67 |
| 2 | 16.5830 | 8.345 | | | | | |
| 3 | −16.2369 | 15.954 | 2.25247 | 2.25800 | 2.24658 | ZnS | 109.67 |
| 4 | −30.2735 | 0.547 | | | | | |
| 5 | 66.8043 | 5.101 | 2.25247 | 2.25800 | 2.24658 | ZnS | 109.67 |
| 6 | −176.0802 | 5.552 | | | | | |
| 7 | −28.7522 | 20.000 | 1.40964 | 1.41785 | 1.39896 | CAF2 | 21.69 |
| 8 | −33.5118 | 16.389 | | | | | |
| 9 | 35.4851 | 1.000 | 2.25247 | 2.25800 | 2.24658 | ZnS | 109.67 |
| 10 | 17.0334 | 0.100 | | | | | |
| 11 | 17.2335 | 5.428 | 1.40964 | 1.41785 | 1.39896 | CAF2 | 21.69 |
| 12 | −66.3217 | 0.300 | | | | | |
| 13(St) | ∞ | 3.551 | | | | | |
| 14 | −549.4603 | 1.000 | 1.40964 | 1.41785 | 1.39896 | CAF2 | 21.69 |
| 15 | 23.2113 | 0.589 | | | | | |
| 16 | 29.178 | 8.885 | 1.45670 | 1.46115 | 1.45102 | BaF2 | 45.08 |
| 17 | −15.7687 | 0.100 | | | | | |
| 18 | −15.8709 | 1.103 | 1.40964 | 1.41785 | 1.39896 | CAF2 | 21.69 |
| 19 | −49.5399 | 0.100 | | | | | |
| 20 | 28.6336 | 7.673 | 1.4567 | 1.46115 | 1.45102 | BaF2 | 45.08 |
| 21 | −29.3746 | 0.001 | | | | | |
| 22 | −48.5729 | 1.000 | 1.34883 | 1.35995 | 1.33404 | MgF2 | 13.46 |
| 23 | 15.1966 | 3.805 | | | | | |
| 24 | 20.644 | 19.995 | 1.40964 | 1.41785 | 1.39896 | CAF2 | 21.69 |
| 25 | −23.7111 | 0.100 | | | | | |
| 26 | ∞ | 1.000 | 1.67524 | 1.71224 | 1.62397 | SAPPHIRE | 7.65 |
| 27 | ∞ | 12.471 | | | | | |

TABLE 28
Example 12

| | |
|---|---|
| f | 11.02 |
| Bf | 13.17 |
| FNo. | 1.4 |
| 2ω [°] | 102.2 |
| Y | 8.00 |

### Example 13

FIG. 26 is a cross-sectional view of a configuration of the imaging lens according to Example 13. The imaging lens according to Example 13 consists of lenses L1 to L6, an aperture stop St, and lenses L7 to L12, in order from the object side to the image side.

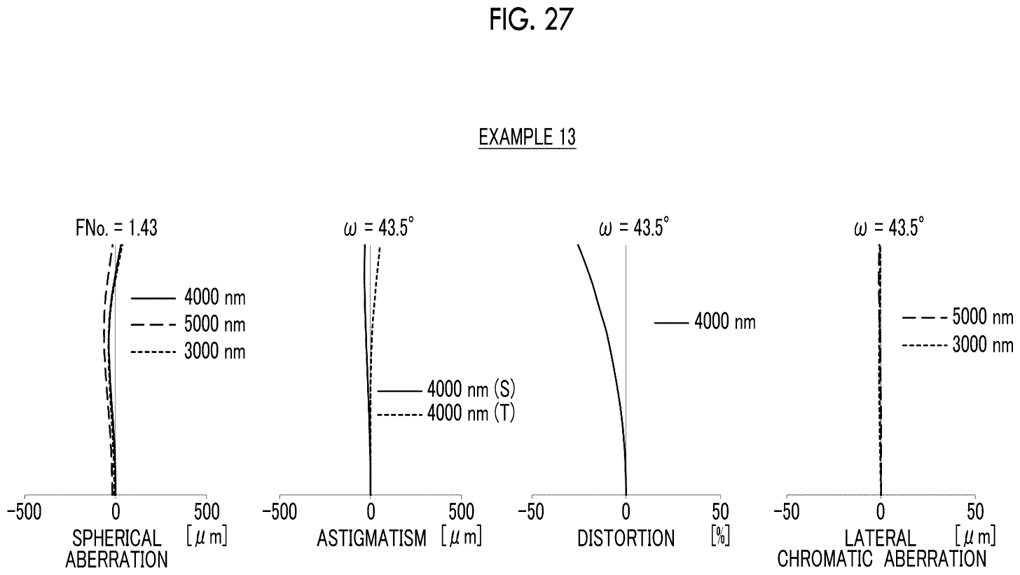

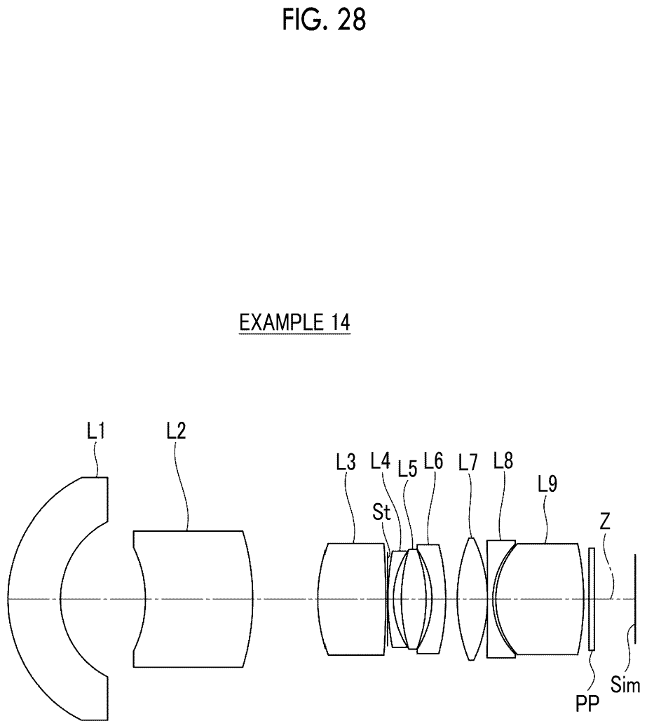

Regarding the imaging lens according to Example 13, Table 29 shows basic lens data, Table 30 shows specifications, and FIG. 27 shows aberration diagrams. The “Isuzu Glass” in the basic lens data indicates Isuzu Glass Ltd.

TABLE 29
Example 13

| | | | | | | | (N4-1)/ |
|---|---|---|---|---|---|---|---|
| Sn | R | D | N4 | N3 | N5 | Material | (N3-N5) |
| 1 | 28.9940 | 3.863 | 2.80008 | 2.82016 | 2.78673 | IIR-SF1 | 53.85 |
| | | | | | | (Isuzu Glass) | |
| 2 | 15.0173 | 7.944 | | | | | |
| 3 | −19.4752 | 17.943 | 2.80008 | 2.82016 | 2.78673 | IIR-SF1 | 53.85 |
| | | | | | | (Isuzu Glass) | |
| 4 | −38.2733 | 0.100 | | | | | |
| 5 | 129.7906 | 5.696 | 2.80008 | 2.82016 | 2.78673 | IIR-SF1 | 53.85 |
| | | | | | | (Isuzu Glass) | |
| 6 | −113.4813 | 3.993 | | | | | |
| 7 | −24.3082 | 20.000 | 1.40964 | 1.41785 | 1.39896 | CAF2 | 21.69 |
| 8 | −25.0630 | 0.218 | | | | | |
| 9 | 21.7992 | 1.000 | 2.80008 | 2.82016 | 2.78673 | IIR-SF1 | 53.85 |
| | | | | | | (Isuzu Glass) | |
| 10 | 16.6094 | 0.100 | | | | | |
| 11 | 16.4135 | 6.658 | 1.40964 | 1.41785 | 1.39896 | CAF2 | 21.69 |
| 12 | −40.3672 | 0.300 | | | | | |
| 13(St) | ∞ | 2.488 | | | | | |
| 14 | −19.2655 | 1.240 | 1.34883 | 1.35995 | 1.33404 | MgF2 | 13.46 |
| 15 | 22.0850 | 0.682 | | | | | |
| 16 | 30.146 | 6.593 | 1.40964 | 1.41785 | 1.39896 | CAF2 | 21.69 |
| 17 | −21.6841 | 1.185 | | | | | |
| 18 | −19.5858 | 1.100 | 1.34883 | 1.35995 | 1.33404 | MgF2 | 13.46 |
| 19 | −30.4094 | 0.101 | | | | | |
| 20 | 29.9868 | 6.161 | 1.40964 | 1.41785 | 1.39896 | CAF2 | 21.69 |
| 21 | −26.993 | 0.003 | | | | | |
| 22 | −73.7787 | 1.000 | 1.34928 | 1.36647 | 1.32659 | LiF | 8.76 |
| 23 | 15.4962 | 6.333 | | | | | |
| 24 | 17.8641 | 5.473 | 1.40964 | 1.41785 | 1.39896 | CAF2 | 21.69 |
| 25 | −65.3521 | 0.105 | | | | | |
| 26 | ∞ | 1.000 | 1.67524 | 1.71224 | 1.62397 | SAPPHIRE | 7.65 |
| 27 | ∞ | 14.975 | | | | | |

TABLE 30
Example 13

| | |
|---|---|
| f | 11.33 |
| Bf | 15.68 |
| FNo. | 1.4 |
| 2ω [°] | 87 |
| Y | 8.00 |

### Example 14

FIG. 28 is a cross-sectional view of a configuration of the imaging lens according to Example 14. The imaging lens according to Example 14 consists of lenses L1 to L3, an aperture stop St, and lenses L4 to L9, in order from the object side to the image side.

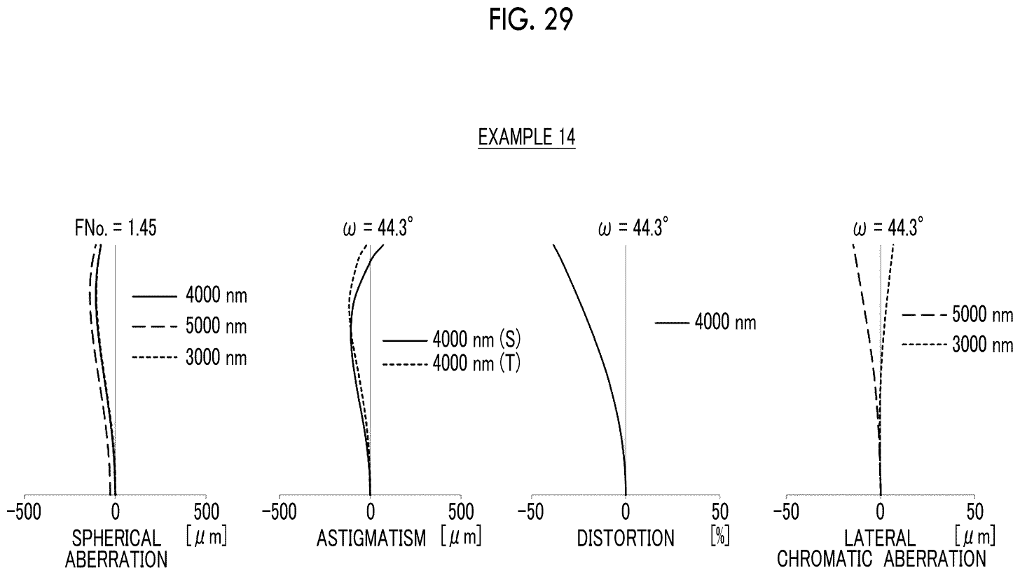

Regarding the imaging lens according to Example 14, Table 31 shows basic lens data, Table 32 shows specifications, and FIG. 29 shows aberration diagrams.

TABLE 31
Example 14

| | | | | | | | (N4-1)/ |
|---|---|---|---|---|---|---|---|
| Sn | R | D | N4 | N3 | N5 | Material | (N3-N5) |
| 1 | 24.1879 | 9.789 | 2.80008 | 2.82016 | 2.78673 | IIR-SF1 | 53.85 |
| | | | | | | (Isuzu Glass) | |
| 2 | 15.5189 | 15.837 | | | | | |
| 3 | −20.7527 | 20.000 | 2.80008 | 2.82016 | 2.78673 | IIR-SF1 | 53.85 |
| | | | | | | (Isuzu Glass) | |
| 4 | −41.0840 | 12.126 | | | | | |
| 5 | 28.4056 | 12.555 | 1.40964 | 1.41785 | 1.39896 | CAF2 | 21.69 |
| 6 | −142.4762 | 0.312 | | | | | |
| 7(St) | ∞ | 0.100 | | | | | |
| 8 | 46.5030 | 1.000 | 1.34883 | 1.35995 | 1.33404 | MgF2 | 13.46 |
| 9 | 15.3681 | 1.496 | | | | | |
| 10 | 30.0175 | 4.603 | 1.40964 | 1.41785 | 1.39896 | CAF2 | 21.69 |
| 11 | −24.5056 | 1.094 | | | | | |
| 12 | −16.0733 | 2.560 | 1.34883 | 1.35995 | 1.33404 | MgF2 | 13.46 |
| 13 | −37.8227 | 2.156 | | | | | |
| 14 | 28.7084 | 5.637 | 1.40964 | 1.41785 | 1.39896 | CAF2 | 21.69 |
| 15 | −24.8259 | 0.001 | | | | | |
| 16 | −648.3314 | 1.000 | 1.34928 | 1.36647 | 1.32659 | LiF | 8.76 |
| 17 | 13.8471 | 0.556 | | | | | |
| 18 | 14.4166 | 16.370 | 1.40964 | 1.41785 | 1.39896 | CAF2 | 21.69 |
| 19 | −45.0986 | 1.000 | | | | | |
| 20 | ∞ | 1.000 | 1.67524 | 1.71224 | 1.62397 | SAPPHIRE | 7.65 |
| 21 | ∞ | 7.618 | | | | | |

TABLE 32
Example 14

| | |
|---|---|
| f | 13.29 |
| Bf | 9.21 |
| FNo. | 1.5 |
| 2ω [°] | 88.6 |
| Y | 8.00 |

### Example 15

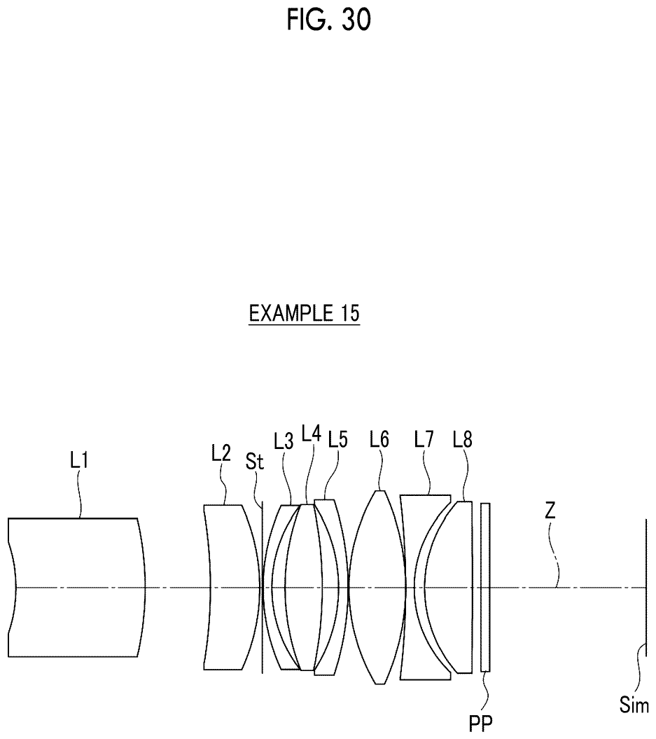

FIG. 30 is a cross-sectional view of a configuration of the imaging lens according to Example 15. The imaging lens according to Example 15 consists of lenses L1 and L2, an aperture stop St, and lenses L3 to L8, in order from the object side to the image side.

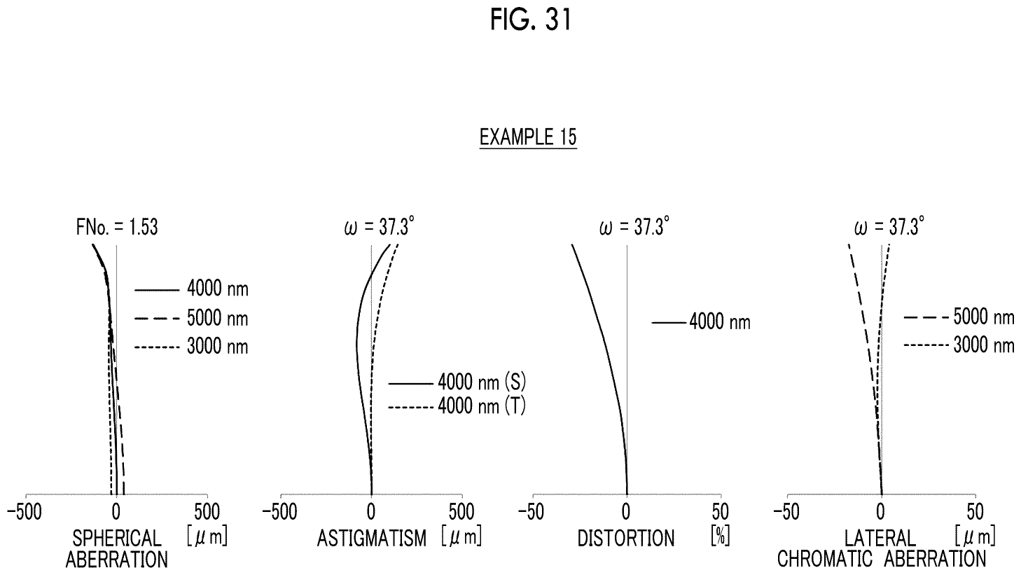

Regarding the imaging lens according to Example 15, Table 33 shows basic lens data, Table 34 shows specifications, and FIG. 31 shows aberration diagrams.

TABLE 33
Example 15

| | | | | | | | (N4-1)/ |
|---|---|---|---|---|---|---|---|
| Sn | R | D | N4 | N3 | N5 | Material | (N3-N5) |
| 1 | −16.8867 | 15.000 | 2.80008 | 2.82016 | 2.78673 | IIR-SF1 | 53.85 |
| | | | | | | (Isuzu Glass) | |
| 2 | −35.8309 | 7.503 | | | | | |
| 3 | −54.0403 | 5.722 | 1.40964 | 1.41785 | 1.39896 | CAF2 | 21.69 |
| 4 | −23.0652 | 0.300 | | | | | |
| 5(St) | ∞ | 0.100 | | | | | |
| 6 | 22.9591 | 1.012 | 1.34883 | 1.35995 | 1.33404 | MgF2 | 13.46 |
| 7 | 15.5712 | 1.530 | | | | | |
| 8 | 26.4346 | 4.317 | 1.40964 | 1.41785 | 1.39896 | CAF2 | 21.69 |
| 9 | −46.6577 | 1.900 | | | | | |
| 10 | −18.0300 | 1.100 | 1.34883 | 1.35995 | 1.33404 | MgF2 | 13.46 |
| 11 | −32.6337 | 0.100 | | | | | |
| 12 | 22.0338 | 6.576 | 1.40964 | 1.41785 | 1.39896 | CAF2 | 21.69 |
| 13 | −27.0414 | 0.001 | | | | | |
| 14 | −90.3485 | 1.000 | 1.34928 | 1.36647 | 1.32659 | LiF | 8.76 |
| 15 | 13.7450 | 1.204 | | | | | |
| 16 | 15.0494 | 5.540 | 1.40964 | 1.41785 | 1.39896 | CAF2 | 21.69 |
| 17 | −1006.5348 | 1.000 | | | | | |
| 18 | ∞ | 1.000 | 1.67524 | 1.71224 | 1.62397 | SAPPHIRE | 7.65 |
| 19 | ∞ | 18.121 | | | | | |

TABLE 34
Example 15

| | |
|---|---|
| f | 14.81 |
| Bf | 19.72 |
| FNo. | 1.5 |
| 2ω [°] | 74.6 |
| Y | 8.00 |

### Example 16

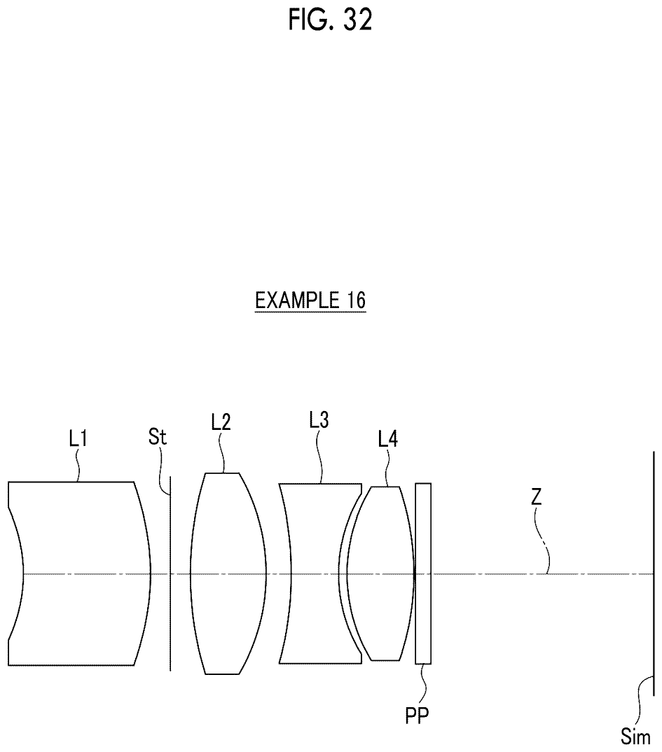

FIG. 32 is a cross-sectional view of a configuration of the imaging lens according to Example 16. The imaging lens according to Example 16 consists of a lens L1, an aperture stop St, and lenses L2 to L4, in order from the object side to the image side.

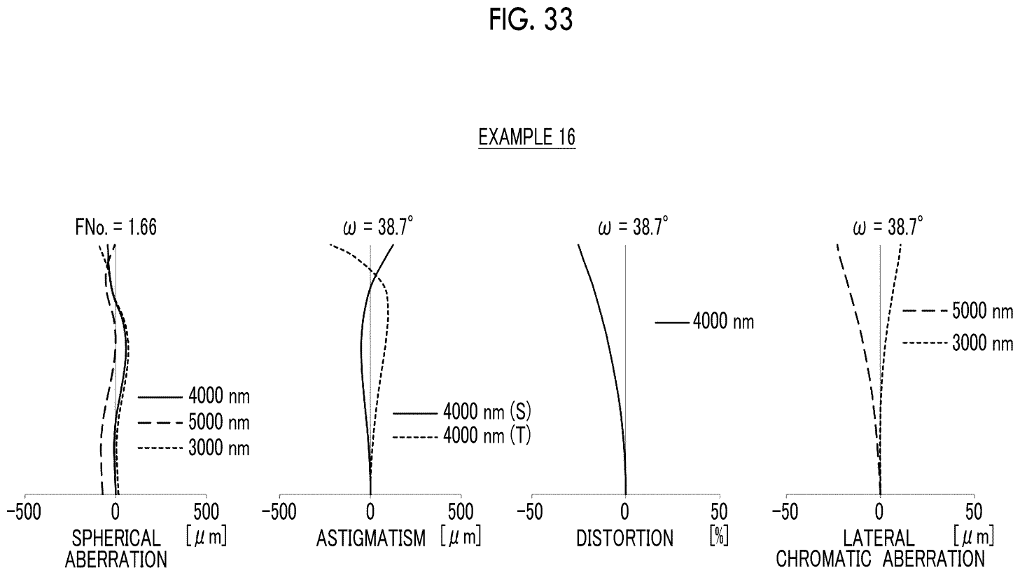

Regarding the imaging lens according to Example 16, Table 35 shows basic lens data, Table 36 shows specifications, Table 37 shows aspherical coefficients thereof, and FIG. 33 shows aberration diagrams.

TABLE 35
Example 16

| | | | | | | | (N4-1)/ |
|---|---|---|---|---|---|---|---|
| Sn | R | D | N4 | N3 | N5 | Material | (N3-N5) |
| *1 | −9.6630 | 8.294 | 2.80008 | 2.82016 | 2.78673 | IIR-SF1 | 53.85 |
| | | | | | | (Isuzu Glass) | |
| *2 | −15.7121 | 1.300 | | | | | |
| 3(St) | ∞ | 1.300 | | | | | |
| 4 | 22.5906 | 4.945 | 1.40964 | 1.41785 | 1.39896 | CAF2 | 21.69 |
| 5 | −13.1606 | 1.636 | | | | | |
| 6 | −22.3279 | 3.051 | 1.34928 | 1.36647 | 1.32659 | LiF | 8.76 |
| 7 | 10.0773 | 0.554 | | | | | |
| 8 | 11.0401 | 4.362 | 1.40964 | 1.41785 | 1.39896 | CAF2 | 21.69 |
| 9 | −17.4853 | 0.100 | | | | | |
| 10 | ∞ | 1.000 | 1.67524 | 1.71224 | 1.62397 | SAPPHIRE | 7.65 |
| 11 | ∞ | 14.552 | | | | | |

TABLE 36
Example 16

| | |
|---|---|
| f | 13.34 |
| Bf | 15.25 |
| FNo. | 1.7 |
| 2ω [°] | 77.4 |
| Y | 8.00 |

TABLE 37
Example 16

| Sn | 1 | 2 |
|---|---|---|
| KA | 0.0000000E+00 | 0.0000000E+00 |
| A3 | 2.0123319E−21 | 1.2382493E−21 |
| A4 | −5.5718042E−05 | 8.6690280E−06 |
| A5 | 1.2427244E−05 | 6.5351415E−06 |
| A6 | 1.3518287E−06 | −4.8624111E−08 |
| A7 | 1.0838683E−06 | −1.0993329E−08 |
| A8 | −1.5319020E−07 | −4.8599040E−09 |
| A9 | −4.3605832E−08 | −2.0381723E−09 |
| A10 | −1.6285785E−08 | 3.0077375E−10 |
| A11 | −1.2773026E−09 | 1.2954168E−10 |
| A12 | 2.2063022E−09 | −3.9343777E−12 |
| A13 | 1.8040365E−10 | −2.1858094E−12 |
| A14 | −4.6579941E−11 | −9.8554592E−14 |
| A15 | −5.7757954E−12 | 4.6442919E−14 |
| A16 | 1.2263282E−13 | −2.1893698E−14 |
| A17 | −6.4849975E−13 | −2.2681731E−16 |
| A18 | −1.2816021E−13 | 9.6114890E−16 |
| A19 | 1.0905961E−13 | 1.5004120E−17 |
| A20 | −1.2255950E−14 | −1.3700843E−17 |

### Example 17

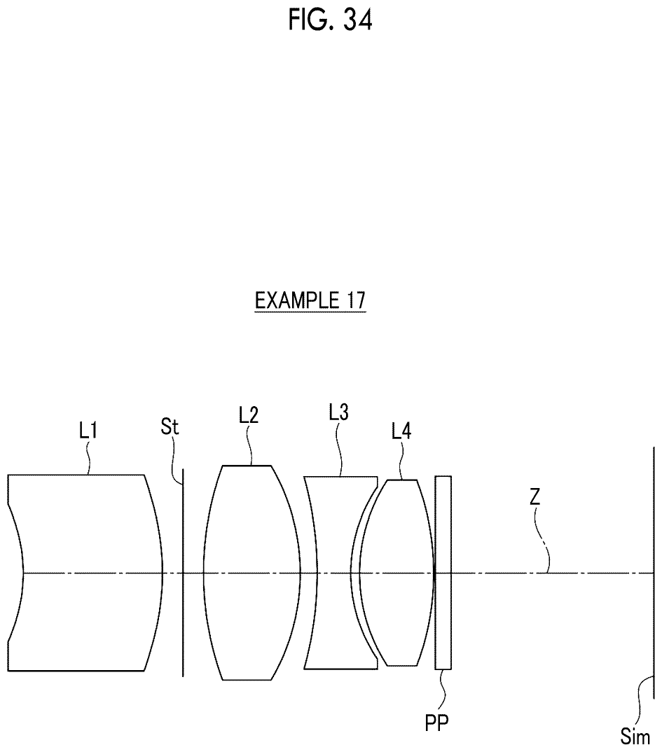

FIG. 34 is a cross-sectional view of a configuration of the imaging lens according to Example 17. The imaging lens according to Example 17 consists of a lens L1, an aperture stop St, and lenses L2 to L4, in order from the object side to the image side.

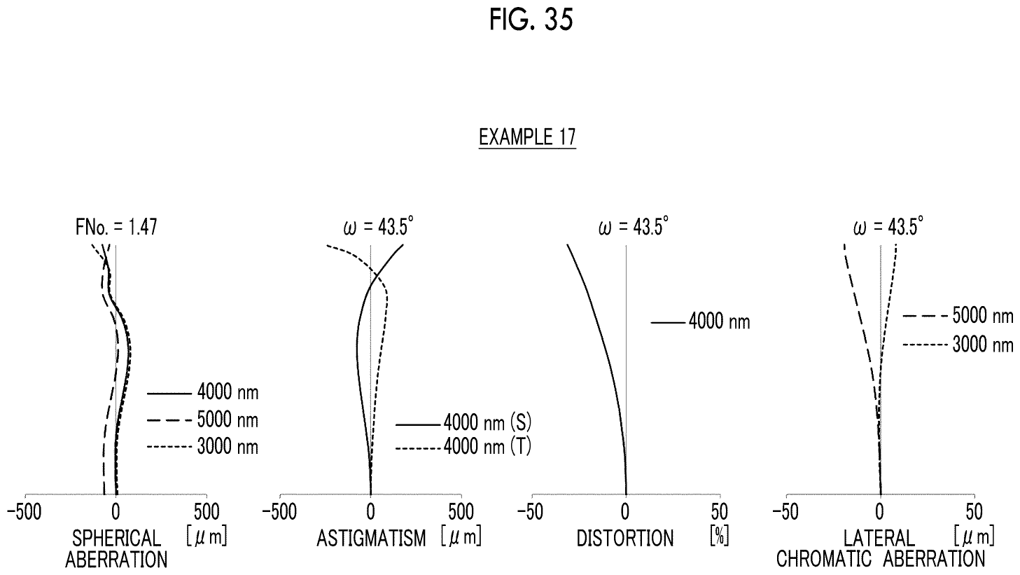

Regarding the imaging lens according to Example 17, Table 38 shows basic lens data, Table 39 shows specifications, Table 40 shows aspherical coefficients thereof, and FIG. 35 shows aberration diagrams.

TABLE 38
Example 17

| | | | | | | | (N4-1)/ |
|---|---|---|---|---|---|---|---|
| Sn | R | D | N4 | N3 | N5 | Material | (N3-N5) |
| *1 | −9.8858 | 8.812 | 2.80008 | 2.82016 | 2.78673 | IIR-SF1 | 53.85 |
| | | | | | | (Isuzu Glass) | |
| *2 | −15.8037 | 1.300 | | | | | |
| 3(St) | ∞ | 1.300 | | | | | |
| 4 | 19.9654 | 6.123 | 1.40964 | 1.41785 | 1.39896 | CAF2 | 21.69 |
| 5 | −13.5275 | 1.073 | | | | | |
| 6 | −22.8225 | 2.087 | 1.34928 | 1.36647 | 1.32659 | LiF | 8.76 |
| 7 | 9.7285 | 0.560 | | | | | |
| 8 | 10.8538 | 4.691 | 1.40964 | 1.41785 | 1.39896 | CAF2 | 21.69 |
| 9 | −16.7613 | 0.100 | | | | | |
| 10 | ∞ | 1.000 | 1.67524 | 1.71224 | 1.62397 | SAPPHIRE | 7.65 |
| 11 | ∞ | 12.838 | | | | | |

TABLE 39
Example 17

| | |
|---|---|
| f | 12.23 |
| Bf | 13.54 |
| FNo. | 1.5 |
| 2ω [°] | 87 |
| Y | 8.00 |

TABLE 40
Example 17

| Sn | 1 | 2 |
|---|---|---|
| KA | 0.0000000E+00 | 0.0000000E+00 |
| A3 | −6.2249142E−22 | 3.9291635E−22 |
| A4 | −5.6170602E−05 | 8.6695550E−06 |
| A5 | 1.4316012E−05 | 6.1250833E−06 |
| A6 | 2.8156465E−06 | 6.6128283E−09 |
| A7 | 5.0763140E−07 | −1.4524675E−08 |
| A8 | −1.3760851E−07 | −5.2469910E−09 |
| A9 | −4.1165339E−08 | −2.1034674E−09 |
| A10 | −1.5864281E−08 | 2.9480861E−10 |
| A11 | −1.1492996E−09 | 1.2669706E−10 |
| A12 | 2.1615247E−09 | −3.9752036E−12 |
| A13 | 1.9941212E−10 | −2.2042475E−12 |
| A14 | −4.4115585E−11 | −1.0101173E−13 |
| A15 | −6.2897036E−12 | 4.7232894E−14 |
| A16 | 2.9596802E−13 | −2.1764146E−14 |
| A17 | −6.5495611E−13 | −2.4924071E−16 |
| A18 | −1.2752651E−13 | 9.6422385E−16 |
| A19 | 1.0731280E−13 | 1.5801154E−17 |
| A20 | −1.2531450E−14 | −1.3549834E−17 |

### Example 18

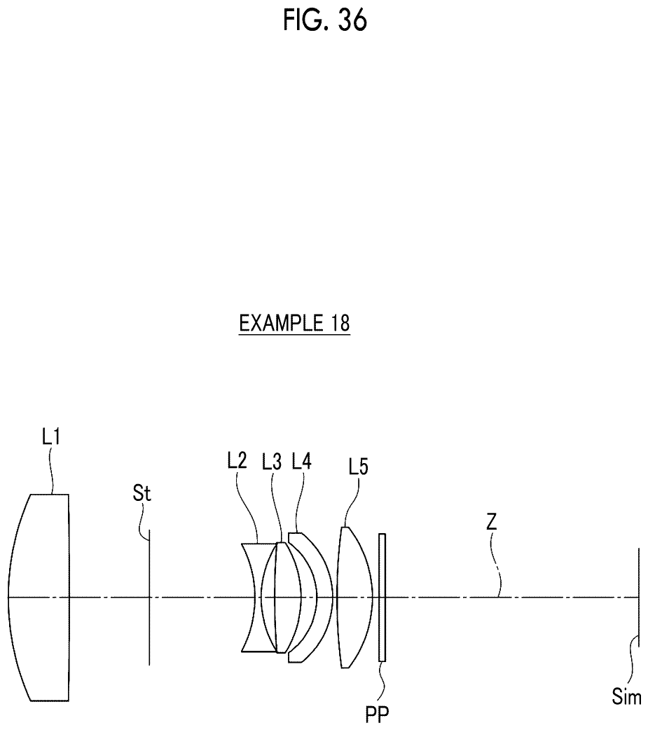

FIG. 36 is a cross-sectional view of a configuration of the imaging lens according to Example 18. The imaging lens according to Example 18 consists of a lens L1, an aperture stop St, and lenses L2 to L5, in order from the object side to the image side.

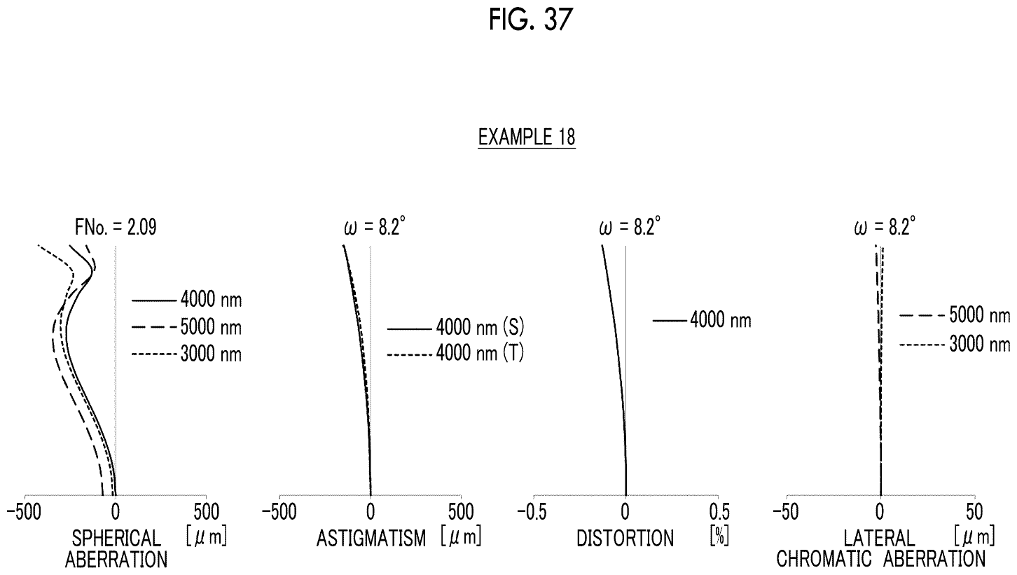

Regarding the imaging lens according to Example 18, Table 41 shows basic lens data, Table 42 shows specifications, and FIG. 37 shows aberration diagrams.

TABLE 41
Example 18

| | | | | | | | (N4-1)/ |
|---|---|---|---|---|---|---|---|
| Sn | R | D | N4 | N3 | N5 | Material | (N3-N5) |
| 1 | 41.6391 | 10.000 | 1.40964 | 1.41785 | 1.39896 | CAF2 | 21.69 |
| 2 | −949.4561 | 13.133 | | | | | |
| 3(St) | ∞ | 17.174 | | | | | |
| 4 | −18.8275 | 1.018 | 1.34928 | 1.36647 | 1.32659 | LiF | 8.76 |
| 5 | 16.4563 | 2.217 | | | | | |
| 6 | 114.7555 | 4.314 | 1.40964 | 1.41785 | 1.39896 | CAF2 | 21.69 |
| 7 | −17.1765 | 2.591 | | | | | |
| 8 | −11.2248 | 2.601 | 2.80008 | 2.82016 | 2.78673 | IIR-SF1 | 53.85 |
| | | | | | | (Isuzu Glass) | |
| 9 | −13.6530 | 0.701 | | | | | |
| 10 | 88.9006 | 5.809 | 1.40964 | 1.41785 | 1.39896 | CAF2 | 21.69 |
| 11 | −19.1438 | 1.100 | | | | | |
| 12 | ∞ | 1.000 | 1.67524 | 1.71224 | 1.62397 | SAPPHIRE | 7.65 |
| 13 | ∞ | 41.464 | | | | | |

TABLE 42
Example 18

| | |
|---|---|
| f | 55.94 |
| Bf | 43.16 |
| FNo. | 2.1 |
| 2ω [°] | 16.4 |
| Y | 8.00 |

### Example 19

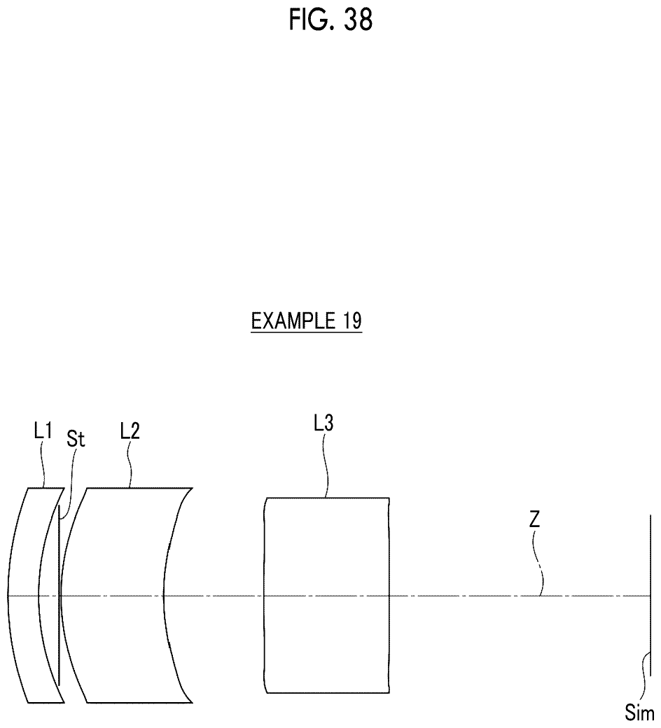

FIG. 38 is a cross-sectional view of a configuration of the imaging lens according to Example 19. The imaging lens according to Example 19 consists of a lens L1, an aperture stop St, and lenses L2 and L3, in order from the object side to the image side.

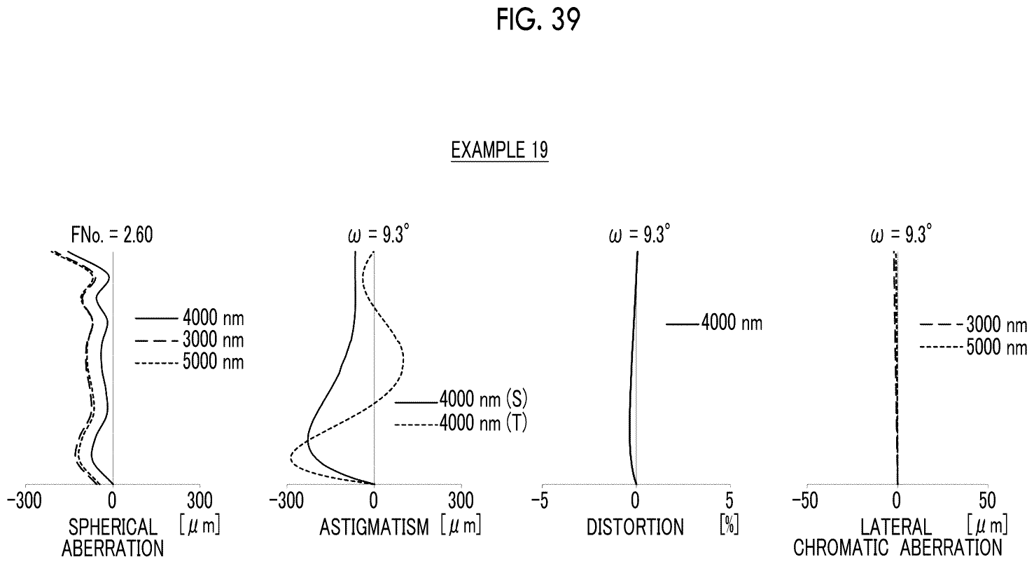

Regarding the imaging lens according to Example 19, Table 43 shows basic lens data, Table 44 shows specifications, Table 45 shows aspherical coefficients thereof, and FIG. 39 shows aberration diagrams.

TABLE 43
Example 19

| | | | | | | | (N4-1)/ |
|---|---|---|---|---|---|---|---|
| Sn | R | D | N4 | N3 | N5 | Material | (N3-N5) |
| 1 | 31.7334 | 3.000 | 1.40964 | 1.41785 | 1.39896 | CAF2 | 21.68 |
| 2 | 25.5684 | 1.987 | | | | | |
| 3(St) | ∞ | 0.200 | | | | | |
| *4 | 23.2060 | 10.013 | 2.51329 | 2.51803 | 2.51029 | IRG22 | 195.34 |
| | | | | | | (SCHOTT) | |
| *5 | 23.6090 | 9.725 | | | | | |
| *6 | 178.8058 | 12.244 | 2.80342 | 2.81105 | 2.79934 | IRG23 | 153.98 |
| | | | | | | (SCHOTT) | |
| *7 | 122715.685 | 25.469 | | | | | |

TABLE 44
Example 19

| | |
|---|---|
| f | 49.86 |
| Bf | 25.47 |
| FNo. | 2.6 |
| 2ω [°] | 18.6 |
| Y | 8.00 |

TABLE 45
Example 19

| Sn | 4 | 5 | 6 | 7 |
|---|---|---|---|---|
| KA | 1.1012506E+00 | 0.0000000E+00 | 1.0000000E+00 | 1.0000000E+00 |
| A3 | −8.8751648E−06 | 1.8128129E−04 | 2.8632758E−04 | −6.5424319E−06 |
| A4 | 2.6037119E−05 | −1.4738801E−04 | −2.9271595E−04 | 2.1536031E−05 |
| AS | −2.6946890E−05 | 2.2066347E−05 | 9.6299503E−05 | −4.1992103E−05 |
| A6 | 6.4541662E−06 | 5.0738896E−06 | −1.0554041E−06 | 1.7251327E−05 |
| A7 | 2.9261107E−07 | −1.5382021E−06 | −7.7326367E−06 | −3.8176913E−07 |
| A8 | −3.5371106E−07 | −1.0222447E−07 | 1.1694598E−06 | −1.4744061E−06 |
| A9 | 3.2000127E−08 | 4.1472625E−08 | 2.4599087E−07 | 2.7447420E−07 |
| A10 | 7.3181853E−09 | 2.1283707E−09 | −6.1535056E−08 | 3.3860131E−08 |
| A11 | −1.3271683E−09 | −7.0068641E−10 | −3.6574352E−09 | −1.2689596E−08 |
| A12 | −5.6464508E−11 | −3.5361489E−11 | 1.5397941E−09 | 4.5737346E−12 |
| A13 | 2.3220890E−11 | 7.3462078E−12 | 1.8857299E−11 | 2.6080436E−10 |
| A14 | −2.6729429E−13 | 3.6273421E−13 | −2.1881806E−11 | −1.1408037E−11 |
| A15 | −2.1332530E−13 | −4.4335550E−14 | 1.2152362E−13 | −2.8155648E−12 |
| A16 | 7.8189899E−15 | −2.0999874E−15 | 1.8138864E−13 | 1.8456798E−13 |
| A17 | 1.0082998E−15 | 1.3942674E−16 | −1.7919592E−15 | 1.5661484E−14 |
| A18 | −5.0709137E−17 | 6.3248334E−18 | −8.1999847E−16 | −1.2200734E−15 |
| A19 | −1.9387589E−18 | −1.7643183E−19 | 5.6673402E−18 | −3.5588290E−17 |
| A20 | 1.1229114E−19 | −7.7180473E−21 | 1.5651045E−18 | 3.0173626E−18 |

Table 46 shows corresponding values of Conditional Expressions (2), (3), (5), and (6) of the imaging lenses according to Examples 1 to 19. Preferable ranges of the conditional expressions may be set by using the corresponding values of the examples shown in Table 46 as the upper limits or the lower limits of the conditional expressions.

TABLE 46

| Expression | | Example | Example | Example | Example | Example | Example | Example |
|---|---|---|---|---|---|---|---|---|
| Number | | 1 | 2 | 3 | 4 | 5 | 6 | 7 |
| (2) | TL/f | 1.49 | 1.48 | 1.48 | 1.21 | 1.55 | 1.54 | 1.67 |
| (3) | Bf/f | 0.56 | 0.56 | 0.57 | 0.56 | 0.69 | 0.68 | 0.62 |
| (5) | TL/2Y | 4.21 | 4.22 | 4.11 | 3.52 | 4.32 | 4.28 | 4.17 |
| (6) | \|fF/fR\| | 4.29 | 4.02 | 4.57 | 0.21 | 3.18 | 3.13 | 3.29 |
| Expression | | Example | Example | Example | Example | Example | Example | Example |
| Number | | 8 | 9 | 10 | 11 | 12 | 13 | 14 |
| (2) | TL/f | 1.39 | 1.79 | 1.31 | 1.85 | 13.29 | 10.23 | 8.76 |
| (3) | Bf/f | 0.54 | 0.68 | 0.54 | 0.68 | 1.20 | 1.38 | 0.69 |
| (5) | TL/2Y | 4.24 | 5.44 | 3.97 | 5.63 | 9.15 | 7.24 | 7.28 |
| (6) | \|fF/fR\| | — | 18.57 | — | 11.40 | 5.16 | 0.58 | 4.25 |

| Expression | | Example | Example | Example | Example | Example |
|---|---|---|---|---|---|---|
| Number | | 15 | 16 | 17 | 18 | 19 |
| (2) | TL/f | 4.90 | 3.05 | 3.23 | 1.84 | 1.26 |
| (3) | Bf/f | 1.33 | 1.14 | 1.11 | 0.77 | 0.51 |
| (5) | TL/2Y | 4.54 | 2.54 | 2.47 | 6.42 | 3.91 |
| (6) | \|fF/fR\| | 5.58 | 6.03 | 18.18 | 2.05 | 8.79 |

In the imaging lenses according to Examples 1 to 19, various aberrations including chromatic aberration are corrected in a medium infrared wavelength range, and favorable optical performance is maintained.

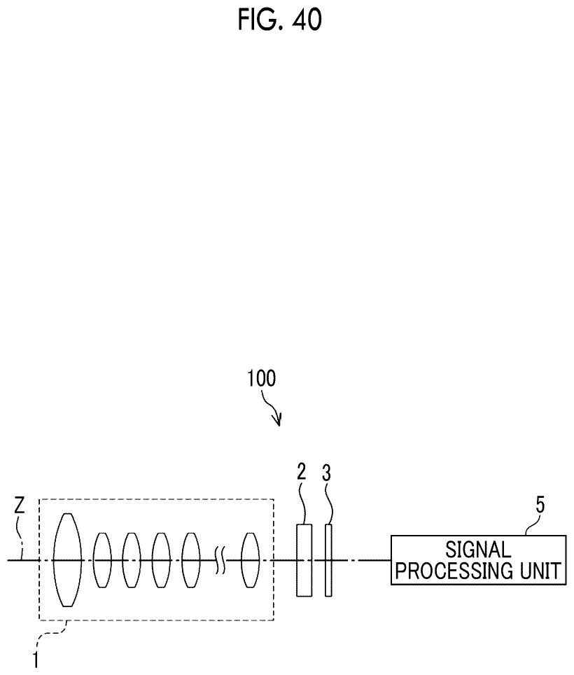

Next, an imaging apparatus according to an embodiment of the present disclosure will be described. FIG. 40 is a schematic configuration diagram of an imaging apparatus 100 according to an embodiment of the present disclosure. The imaging apparatus 100 is configured to include an imaging lens 1 according to the embodiment of the present disclosure. Examples of the imaging apparatus 100 include a camera for factory automation (FA), a camera for machine vision (MV), a surveillance camera, and an in-vehicle camera.

The imaging apparatus 100 comprises an imaging lens 1, a filter 2, an imaging element 3, and a signal processing unit 5. It should be noted that FIG. 40 conceptually shows the imaging lens 1.

The imaging element 3 captures an optical image, which is formed by the imaging lens 1, and converts the optical image into an electric signal. For example, a charge coupled device (CCD) or a complementary metal oxide semiconductor (CMOS) can be used as the imaging element 3. The imaging element 3 is disposed such that the imaging surface thereof coincides with the image plane of the imaging lens 1. It should be noted that although FIG. 40 shows only one imaging element 3, a so-called three-plate-type imaging apparatus having three imaging elements may be used. The signal processing unit 5 performs calculation processing on an output signal from the imaging element 3.

The technique of the present disclosure has been hitherto described through embodiments and examples, but the technique of the present disclosure is not limited to the above-mentioned embodiments and examples, and may be modified into various forms. For example, values such as the curvature radius, the surface spacing, the refractive index, and the aspherical coefficient of each lens are not limited to the values shown in the examples, and different values may be used therefor.

Regarding the above-mentioned embodiments and examples, the following Supplementary Notes will be further disclosed.

### Supplementary Note 1

An imaging lens comprising:
a plurality of lenses; and
a stop,
in which assuming that a refractive index of each lens included in the imaging lens at a wavelength of 4000 nm is N4,
   at least one lens of the plurality of lenses is an LA lens that satisfies Conditional Expression (1A) represented by

N4<1.5 (1A), and
at least one lens of the plurality of lenses is an LB lens that satisfies Conditional Expression (1B) represented by

2<N4 (1B).

### Supplementary Note 2

The imaging lens according to Supplementary Note 1, in which at least one LA lens is disposed closer to the object side than the stop.

### Supplementary Note 3

The imaging lens according to Supplementary Note 1 or 2, in which at least one LB lens is disposed closer to an object side than the stop.

### Supplementary Note 4

The imaging lens according to any one of Supplementary Notes 1 to 3, in which at least one LA lens is disposed closer to an image side than the stop.

### Supplementary Note 5

The imaging lens according to any one of Supplementary Notes 1 to 4, in which at least one LB lens is disposed closer to an image side than the stop.

### Supplementary Note 6

The imaging lens according to any one of Supplementary Notes 1 to 5, in which the imaging lens includes at least two aspherical lenses.

### Supplementary Note 7

The imaging lens according to any one of Supplementary Notes 1 to 6, in which all the lenses included in the imaging lens satisfy Conditional Expression (1C) represented by

N4<5 (1C).

### Supplementary Note 8

The imaging lens according to any one of Supplementary Notes 1 to 7, in which assuming that
a sum of a distance on an optical axis from a lens surface closest to an object side in the imaging lens to a lens surface closest to an image side in the imaging lens and a back focal length of the imaging lens in terms of an air-equivalent distance at the wavelength of 4000 nm is TL, and
a focal length of the imaging lens at the wavelength of 4000 nm is f,
Conditional Expression (2) is satisfied, which is represented by

TL/f<20 (2).

### Supplementary Note 9

The imaging lens according to any one of Supplementary Notes 1 to 8, in which assuming that
a back focal length of the imaging lens in terms of an air-equivalent distance at the wavelength of 4000 nm is Bf, and
a focal length of the imaging lens at the wavelength of 4000 nm is f,
Conditional Expression (3) is satisfied, which is represented by

0.3<Bf/f (3).

### Supplementary Note 10

The imaging lens according to any one of supplementary Notes 1 to 9, in which assuming that
a refractive index of each lens included in the imaging lens at a wavelength of 3000 nm is N3, and
a refractive index of each lens included in the imaging lens at a wavelength of 5000 nm is N5,
the imaging lens includes at least one aspherical lens that satisfies Conditional Expression (4A) represented by

100<(N4−1)/(N3−N5)<400 (4A).

### Supplementary Note 11

The imaging lens according to any one of Supplementary Notes 1 to 10, in which at least one lens of the plurality of lenses is a lens having a concave lens surface, and at least one lens of the plurality of lenses is a lens having a convex lens surface,
assuming that
   a refractive index of each lens included in the imaging lens at a wavelength of 3000 nm is N3, and
   a refractive index of each lens included in the imaging lens at a wavelength of 5000 nm is N5,
   at least one lens having the concave lens surface satisfies Conditional Expression (4B) represented by

0<(N4−1)/(N3−N5)<180 (4B), and
at least one lens having the convex lens surface satisfies Conditional Expression (4C) represented by

180<(N4−1)/(N3−N5)<400 (4C).

### Supplementary Note 12

The imaging lens according to any one of Supplementary Notes 1 to 11, in which assuming that
a refractive index of each lens included in the imaging lens at a wavelength of 3000 nm is N3, and
a refractive index of each lens included in the imaging lens at a wavelength of 5000 nm is N5,
the imaging lens includes at least one spherical lens that satisfies Conditional Expression (4D) represented by

0<(N4−1)/(N3−N5)<250 (4D).

### Supplementary Note 13

The imaging lens according to any one of Supplementary Notes 1 to 12, in which the imaging lens includes at least three lenses.

### Supplementary Note 14

The imaging lens according to any one of Supplementary Notes 1 to 13, in which assuming that
a sum of a distance on an optical axis from a lens surface closest to an object side in the imaging lens to a lens surface closest to an image side in the imaging lens and a back focal length of the imaging lens in terms of an air-equivalent distance at the wavelength of 4000 nm is TL, and
a maximum image height of the imaging lens is Y,
Conditional Expression (5) is satisfied, which is represented by

0.5<TL/2Y<20 (5).

### Supplementary Note 15

The imaging lens according to any one of Supplementary Notes 1 to 14, in which assuming that
a composite focal length of all the lenses closer to an object side than the stop at the wavelength of 4000 nm is fF, and
a composite focal length of all the lenses closer to an image side than the stop at the wavelength of 4000 nm is fR,
Conditional Expression (6) is satisfied, which is represented by

|fF/fR|<40 (6).

### Supplementary Note 16

The imaging lens according to any one of Supplementary Notes 1 to 15, in which the LA lens is made of a crystalline material.

### Supplementary Note 17

The imaging lens according to any one of Supplementary Notes 1 to 16, in which the imaging lens includes, successively in order from a position closest to an object side to an image side, a first lens that has a positive or negative refractive power, a second lens that has a positive refractive power, and a third lens that has a negative refractive power.

### Supplementary Note 18

The imaging lens according to any one of Supplementary Notes 1 to 17, in which a negative lens is disposed adjacent to an image side of the stop.

### Supplementary Note 19

The imaging lens according to Supplementary Note 18, in which a positive lens is disposed adjacent to the image side of the negative lens.

### Supplementary Note 20

An imaging apparatus comprising:
the imaging lens according to any one of claims 1 to 19; and
an imaging element that captures an image formed by the imaging lens.

What is claimed is:

1. An imaging lens comprising:
a plurality of lenses; and
a stop,
wherein assuming that a refractive index of each lens included in the imaging lens at a wavelength of 4000 nm is N4,
at least one lens of the plurality of lenses is an LA lens that satisfies Conditional Expression (1A) represented by
N4<1.5 (1A), and
at least one lens of the plurality of lenses is an LB lens that satisfies Conditional Expression (1B) represented by
2<N4 (1B).

2. The imaging lens according to claim 1,
wherein at least one LA lens is disposed closer to an object side than the stop.

3. The imaging lens according to claim 1,
wherein at least one LB lens is disposed closer to an object side than the stop.

4. The imaging lens according to claim 1,
wherein at least one LA lens is disposed closer to an image side than the stop.

5. The imaging lens according to claim 1,
wherein at least one LB lens is disposed closer to an image side than the stop.

6. The imaging lens according to claim 1,
wherein the imaging lens includes at least two aspherical lenses.

7. The imaging lens according to claim 1,
wherein all the lenses included in the imaging lens satisfy Conditional Expression (1C) represented by
N4<5 (1C).

8. The imaging lens according to claim 1,
wherein assuming that
a sum of a distance on an optical axis from a lens surface closest to an object side in the imaging lens to a lens surface closest to an image side in the imaging lens and a back focal length of the imaging lens in terms of an air-equivalent distance at the wavelength of 4000 nm is TL, and
a focal length of the imaging lens at the wavelength of 4000 nm is f,
Conditional Expression (2) is satisfied, which is represented by
TL/f<20 (2).

9. The imaging lens according to claim 1,
wherein assuming that
a back focal length of the imaging lens in terms of an air-equivalent distance at the wavelength of 4000 nm is Bf, and
a focal length of the imaging lens at the wavelength of 4000 nm is f,
Conditional Expression (3) is satisfied, which is represented by
0.3<Bf/f (3).

10. The imaging lens according to claim 1,
wherein assuming that
a refractive index of each lens included in the imaging lens at a wavelength of 3000 nm is N3, and
a refractive index of each lens included in the imaging lens at a wavelength of 5000 nm is N5,
the imaging lens includes at least one aspherical lens that satisfies Conditional Expression (4A) represented by
100<(N4−1)/(N3−N5)<400 (4A).

11. The imaging lens according to claim 1,
wherein at least one lens of the plurality of lenses is a lens having a concave lens surface, and at least one lens of the plurality of lenses is a lens having a convex lens surface,
assuming that
a refractive index of each lens included in the imaging lens at a wavelength of 3000 nm is N3, and
a refractive index of each lens included in the imaging lens at a wavelength of 5000 nm is N5,
at least one lens having the concave lens surface satisfies Conditional Expression (4B) represented by
0<(N4−1)/(N3−N5)<180 (4B), and
at least one lens having the convex lens surface satisfies Conditional Expression (4C) represented by
180<(N4−1)/(N3−N5)<400 (4C).

12. The imaging lens according to claim 1,
wherein assuming that
a refractive index of each lens included in the imaging lens at a wavelength of 3000 nm is N3, and
a refractive index of each lens included in the imaging lens at a wavelength of 5000 nm is N5,
the imaging lens includes at least one spherical lens that satisfies Conditional Expression (4D) represented by
0<(N4−1)/(N3−N5)<250 (4D).

13. The imaging lens according to claim 1,
wherein the imaging lens includes at least three lenses.

14. The imaging lens according to claim 1,
wherein assuming that
a sum of a distance on an optical axis from a lens surface closest to an object side in the imaging lens to a lens surface closest to an image side in the imaging lens and a back focal length of the imaging lens in terms of an air-equivalent distance at the wavelength of 4000 nm is TL, and
a maximum image height of the imaging lens is Y,
Conditional Expression (5) is satisfied, which is represented by
0.5<TL/2Y<20 (5).

15. The imaging lens according to claim 1,
wherein assuming that
a composite focal length of all the lenses closer to an object side than the stop at the wavelength of 4000 nm is fF, and
a composite focal length of all the lenses closer to an image side than the stop at the wavelength of 4000 nm is fR,
Conditional Expression (6) is satisfied, which is represented by

|fF/fR|<40 (6).

16. The imaging lens according to claim 1,
wherein the LA lens is made of a crystalline material.

17. The imaging lens according to claim 1,
wherein the imaging lens includes, successively in order from a position closest to an object side to an image side, a first lens that has a positive or negative refractive power, a second lens that has a positive refractive power, and a third lens that has a negative refractive power.

18. The imaging lens according to claim 1,
wherein a negative lens is disposed adjacent to an image side of the stop.

19. The imaging lens according to claim 18,
wherein a positive lens is disposed adjacent to the image side of the negative lens.

20. An imaging apparatus comprising:
the imaging lens according to claim 1; and
an imaging element that captures an image formed by the imaging lens.
